(19) United States
(12) Patent Application Publication
(10) Pub. No.: US 2025/0314986 A1
(43) Pub. Date: Oct. 9, 2025

(54) ELECTROPHOTOGRAPHIC MEMBER, PROCESS CARTRIDGE, AND ELECTROPHOTOGRAPHIC IMAGE FORMING APPARATUS

(71) Applicant: CANON KABUSHIKI KAISHA, Tokyo (JP)

(72) Inventors: KATSUYA KODAMA, Kanagawa (JP); MASATSUGU HONGO, Shizuoka (JP); HIROAKI WATANABE, Kanagawa (JP); ATSUSHI UEMATSU, Shizuoka (JP); YUICHI KIKUCHI, Shizuoka (JP); SATORU NISHIOKA, Shizuoka (JP); YASUHIRO FUSHIMOTO, Kanagawa (JP)

(21) Appl. No.: 19/095,468

(22) Filed: Mar. 31, 2025

(30) Foreign Application Priority Data
Apr. 4, 2024 (JP) 2024-060840

(51) Int. Cl. G03G 15/02; G03G 21/18

(52) U.S. Cl. CPC G03G 15/0233; G03G 21/1814

(57) ABSTRACT

An electrophotographic member comprising a substrate having a conductive outer surface, and a conductive layer disposed on the outer surface of the substrate, wherein the conducive layer comprises a matrix comprising a first rubber, and a plurality of domains dispersed in the matrix, and a sample obtained from the conductive layer comprises a predetermined volume ratio and quantity of domains, and the domain comprises a second rubber and an electronic conducive agent, and comprises a domain A of which centroid of volume exists in the domain, and predetermined outer peripheral region and an inner region do not overlap, and elasticity of the outer peripheral region is higher than elasticity of the inner region by a predetermined ratio.

### BACKGROUND OF THE INVENTION

### Field of the Invention

The present disclosure relates to an electrophotographic member, a process cartridge, and an electrophotographic image forming apparatus that can be used for electrophotography.

### Description of the Related Art

In an electrophotographic image forming apparatus, conductive members are used as electrophotographic members such as a charging member, a transfer member, and a developing member. The conductive members play a role of transporting the charges from a conductive support member to a surface of the conductive member, and provides charges to a contacted object by discharging or triboelectric charging. As the conductive member, an electrophotographic member, constituted of a conductive support member and a conductive layer disposed on the support member, for example, is known.

The charging member is a member that generates discharge together with an electrophotographic photosensitive member, so as to charge the surface of the electrophotographic photosensitive member, and has to perform uniform charging on the electrophotographic photosensitive member. In recent years, an electrophotographic member having a longer service life than conventional electrophotographic members is demanded, in order to support a cleanerless system, which does not comprise a cleaning member for the surface of the photosensitive drum to downsize the electrophotographic image forming apparatus, or a system that contacts a cleaning member with light pressure.

Specifically, an electrophotographic member, which can maintain image quality for a long period of time without changing physical properties of the electrophotographic member even if contaminants adhere to the member, is demanded.

Japanese Patent Application Publication No. 2021-067924 discloses a charging member where a conductive layer is a rubber composition having a matrix-domain structure, which comprises a matrix that comprises a first cross-linked rubber, and a plurality of domains dispersed in the matrix. The impedance of this conductive layer is from 1.0×1.0³Ω to 1.0×10⁸Ω, and the domain form is close to a perfect circle.

### SUMMARY OF THE INVENTION

The present inventors evaluated recently processes of electrophotographic members of which life span is longer, particularly the cleaner process where contamination of charging members is intense. Thereby the present inventors ascertained that in the case of the matrix-domain structure disclosed in Japanese Patent Application Publication No. 2021-067924, the generation of white spots can be suppressed by excellent discharge characteristics, but problems still remain in terms of prolonging life, and improvement here is still required.

Specifically, after the transfer process, toner remaining on the photosensitive member, without being transferred to an intermediate transfer member or paper, reaches the surface of the charging member, and this surface is repeatedly deformed by the untransferred toner in conjunction with the charging member rotating over a long period of time. This increases resistance, and in some cases, black spots are generated thereby.

The present disclosure is oriented toward an electrophotographic member that can suppress the generation of white spots as well as black spots, even when the member is applied to the electrophotographic image forming process of the main body having a longer service life.

Moreover, the present disclosure is oriented toward a process cartridge to form a high quality electrophotographic image. Furthermore, the present disclosure is oriented toward an electrophotographic image forming apparatus that can form a high quality electrophotographic image.

The present disclosure provides an electrophotographic member, comprising:
a substrate having a conductive outer surface; and a conductive layer disposed on the outer surface of the substrate, wherein
the conductive layer comprises
   a matrix comprising a first rubber, and
   a plurality of domains dispersed in the matrix,
at least eight samples out of cubic samples of which one side is 6 μm, which are sampled from nine locations of the conductive layer, satisfy <Condition 1> and <Condition 2> below in FIB-SEM measurement:
<Condition 1> a ratio of a total volume of the plurality of domains to a volume of the sample is 10 to 40 volume %; and
<Condition 2> a number of the plurality of domains comprised in the sample is 10 to 2400, wherein
the plurality of domains comprised in each sample that satisfies the <Condition 1> and <Condition 2> comprise at least one domain A, and
the domain A satisfies <Condition 3> to <Condition 6> below:
<Condition 3> the domain A comprises a second rubber and an electronic conductive agent;
<Condition 4> a centroid of volume of the domain A exists in the domain;
<Condition 5> on a cross-section of the domain A passing through the centroid of volume, an outer peripheral region, which is a region of a 10 nm distance from an outer edge of the domain to the centroid of volume, and an inner region, which is a region of a 10 nm distance from the centroid of volume to the outer edge of the domain, do not overlap; and
<Condition 6> in a case where elasticity measured in the outer peripheral region of the cross-section in <Condition 5> is Eout, and elasticity measured in the inner region is Ein, Eout/Ein>1.10 is satisfied.

According to at least one aspect of the present disclosure, an electrophotographic member that can suppress the generation of white spots as well as block spots can be provided, even when the member is applied to the electrophotographic image forming process of a main body having a longer service life. Further, according to at least one aspect of the present disclosure, a process cartridge and an electrophotographic image forming apparatus, which can form a high quality electrophotographic image, can be provided.

Further features of the present invention will become apparent from the following description of exemplary embodiments with reference to the attached drawings.

### BRIEF DESCRIPTION OF THE DRAWINGS

FIG. 1 is an external view of an electrophotographic roller;

FIGS. 2A to 2F are diagrams depicting a structure of a domain in a conductive layer;

FIGS. 3A to 3C are diagrams depicting a domain in a conductive layer;

FIGS. 4A to 4D are diagrams depicting a state of a domain during compression;

FIGS. 5A and 5B are diagrams depicting conditions to extract a sample to measure physical properties;

FIG. 6 is a diagram depicting a general configuration of a process cartridge; and

FIG. 7 is a diagram depicting a general configuration of an electrophotographic image forming apparatus.

### DESCRIPTION OF THE EMBODIMENTS

In the present disclosure the notations “from XX to YY” and “XX to YY” representing a numerical value range signify, unless otherwise specified, a numerical value range that includes the lower limit and the upper limit of the range, as endpoints. In a case where numerical value ranges are described in stages, the upper limits and the lower limits of the respective numerical value ranges can be combined arbitrarily. In the present disclosure, for instance, a wording such as “at least one selected from the group consisting of XX, YY and ZZ” encompasses XX, YY and ZZ, a combination of XX and YY, a combination of XX and ZZ, a combination of YY and ZZ, and a combination of XX, YY and ZZ.

Embodiments of the present disclosure will be described in detail with reference to the drawings. Composing elements described in the embodiments, however, are merely examples, and are not intended to limit the scope of the present disclosure thereto.

The present disclosure suppresses black spots in the long term use of a system of which amount of contaminating substances that reach the charging member is high, such as a cleanerless system or a system in which a cleaning member contacts the photosensitive drum with light pressure.

The present inventors estimate that the following case are the reasons why black dots are generated in the charging member according to Japanese Patent Application Publication No. 2021-067924.

The contaminating substances are toner and external additives which are not transferred to paper or an intermediate transfer member in the transfer process of the electrophotographic image forming process, and which remain on the surface of the photosensitive drum, and reach and adhere to the charging member. The problem the current invention is to solve is that these contaminating substances adhere to and deposit on the surface of the charging member when the electrophotographic image forming apparatus (hereafter also called “image forming apparatus”) is used over a long period of time.

The present inventors estimate that the following change of the charging member caused by the contaminating substances is the mechanism of generating black spots, since black spots, generated in the charging member used over a long period of time, were still generated even after cleaning the contaminating substances.

Generally, the charging member is often designed with rubber elasticity to ensure contact with the drum. This means that the surface of the charging member, on which the contaminating substances adhere, is locally depressed at the moment of contacting the drum, and thereby deformation is generated. When the contact is released, deformation is released.

Further, the conductivity of the charging member is normally generated by adding an electronic conductive agent (e.g. carbon black), allowing charges to be transported using the electronic conductive agent as a conductive path, for example, so as to ensure conductivity over a long period of time.

Therefore, if the deformation and release of deformation are repeated by contact with the drum at the portion where the contaminating substance adheres, the connection of the electronic conductive agents in the charging member change, and the conductive path is disconnected. This results in an increase in resistance and a decrease in the discharge amount in this portion, and the present inventors estimate that this is the cause of the generation of black spots.

Even in the matrix-domain structure disclosed in Japanese Patent Application Publication No. 2021-067924, where an electronic conductive agent is filled and dispersed in a spherical domain, it can be estimated that the conductive path of carbon black, which exists in the domain generating conductivity, changes, and resistance of this changed portion increases.

Considering this mechanism of generating black spots, the present inventors conceived that in the matrix-domain structure, suppressing deformation of the domain comprising the electronic conductive agent and suppressing changes of the conductive path thereby is effective to suppress the generation of black spots on the image.

As a result of closely analyzing the phenomena that one domain comprising the electronic conductive agent in the matrix is compressed by receiving a load, the present inventors discovered that deformation is larger in the center region of the domain compared with an outer region in the domain. In other words, the conductive path existing at the inner side of the domain is subject to the compression phenomena more strongly than the conductive path existing at the outer side of the domain.

Based on the results of the above study, the present inventors considered the configuration of the electrophotographic member having the matrix-domain structure, where the domain has a core-shell structure, and a large amount of carbon black (electronic conductive agent) exists in the shell portion.

By unevenly distributing the electronic conductive agent, which contributes to generating conductivity in a shell region where deformation is small when the domain is compressed, the conductivity is generated only in the shell region which is not influenced by compression very much, and an increase in resistance in the domain can be suppressed.

In addition, the present inventors discovered that by unevenly distributing the electronic conductive agent in the shell region and minimizing the amount of the electronic conductive agent in the core portion, the elasticity of the core portion can be much smaller than the shell portion, whereby deformation can be concentrated more to the core portion, and deformation of the shell portion can be further decreased. This tendency is more obvious in the case where the elasticity of the outer portion of the domain is larger than the inner portion of the domain. This is because when an object, constituted of two materials having mutually different elasticities, is compressed and deformed, the softer portion is deformed first.

As described above, in order to provide a high quality image by suppressing the generation of black spots, caused by an increase in resistance in the contaminant adhering portion, over a long period of time, an electrophotographic member, comprising a substrate having a conductive outer surface and a specific conductive layer disposed on the outer surface, can be used.

### Electrophotographic Member

The electrophotographic member comprises: a substrate having a conductive outer surface; and a conductive layer disposed on this outer surface of the substrate. The electrophotographic member may be an electrophotographic roller, for example. The electrophotographic member will now be described using an electrophotographic roller as an example.

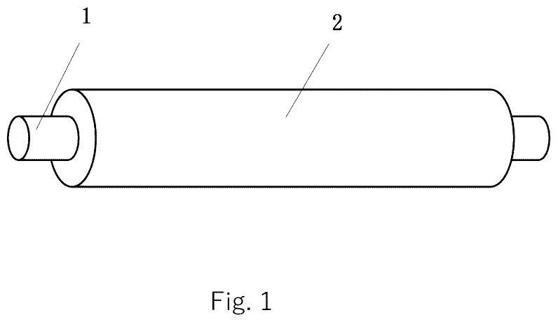

FIG. 1 is a schematic external view of an electrophotographic roller. This electrophotographic roller comprises a conductive layer 2 on an outer periphery of a substrate 1 (shaft core 1). The conductive layer 2 is an elastic layer, for example. Both ends of the substrate 1 may be exposed without being coated by the conductive layer 2. The electrophotographic roller may be a charging roller. The charging roller is disposed in the image forming apparatus, as charging means for charging a photosensitive member. Specifically, the charging roller contacts a photosensitive drum and is moved along with the photosensitive member of the photosensitive drum, and performs charging processing using friction at the contact portion between the photosensitive drum and the charging roller.

### Substrate (Conductive Support Member)

The substrate 1 used for the electrophotographic roller has conductivity and a function to support the conductive layer and the like disposed on the outer periphery thereof. The material may be, for example, such metal as iron, copper, stainless steel, aluminum and nickel, or an alloy thereof. The surface of the substrate 1 may be treated by plating or the like to provide scratch resistance. Further, a shaft core generated by coating the surface of a resin substrate with a metal or the like to provide surface conductivity, or a shaft core formed by a conductive resin composition, may also be used as the substrate.

An adhesive layer (not illustrated) may be disposed between the substrate 1 and the conductive layer 2. In this case, the adhesive layer preferably has conductivity. To provide conductivity, an appropriate known conductive agent (e.g. ionic conductive agent, electronic conductive agent) may be selected and used alone, or a combination of two or more types of such conductive agents may be used.

For the binder of the adhesive, a thermosetting resin or a thermoplastic resin can be used, and a known binder, such as urethane, acrylic, polyester, polyether and epoxy resin may be used. For the adhesive, a commercially available one may be used, such as Metaloc N33 (manufactured by Toyokagaku Kenkyusho Co. Ltd.). To coat the adhesive, a known method, such as roll coating, sponge coating, and spray coating may be used.

For the adhesive layer between the substrate 1 and the conductive layer 2, an adhesive layer may be disposed on the entire surface where the substrate 1 and the conductive layer 2 are in contact, or an adhesive layer may be disposed only in a 5 mm to 20 mm width range on both ends of the surface where the substrate 1 and the conductive layer 2 are in contact. For the thickness of the adhesive layer, 1 to 10 μm is preferable in terms of adhesive performance between the substrate and the conductive layer.

### Conductive Layer

### Matrix-Domain Structure

The conductive layer comprises a matrix comprising a first rubber, and a plurality of domains disposed in this matrix. In other words, the conductive layer has a matrix-domain structure. As mentioned above, in the conductive layer, the domain has a core-shell structure, for example, where an electronic conductive agent (conductive particles) such as carbon black is filled in the shell portion.

### Core-Shell Structure of Domain

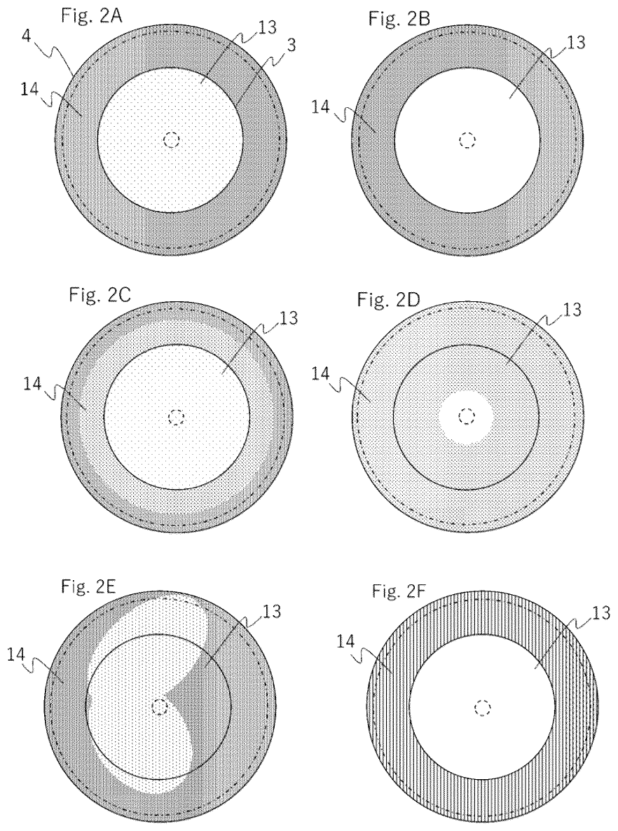

FIGS. 2A to 2F indicate examples of the core-shell structure in a domain.

FIGS. 2A to 2F are cross-sectional views of a domain sectioned at a plain passing through the centroid of the volume. In FIGS. 2A to 2F, the amount of the electronic conductive agent is indicated by the density of shading, which indicates that the amount of the electronic conductive agent is higher as the shading is darker.

In FIG. 2A, the contour indicates a boundary 4 between the matrix and the shell. The domain has a boundary 3 between the core and the shell. FIG. 2A is a domain structure where the shell portion 14 comprises relatively more electronic conductive agent than the core portion 13. Here the core portion 13 deforms first during compression, which suppresses deformation of the shell portion 14. Therefore, an increase in resistance of the domain can be suppressed, and the generation of black spots can be prevented.

FIG. 2B is a domain structure where the core portion 13 comprises a second rubber which does not comprise the electronic conductive agent, and the shell portion 14 comprises a second rubber comprising the electronic conductive agent. Here the core portion 13 deforms first, even more so than FIG. 2A, during compression, which suppresses deformation of the shell portion 14. Therefore, an increase in resistance of the domain can be suppressed more than the structure in FIG. 2A, and the generation of black spots can be prevented.

FIG. 2C is a domain structure where the amount of the electronic conductive agent gradually increases from the core portion 13 to the domain outer edge portion. Here the elasticity is higher in the shell portion 14 than the core portion 13, hence the core portion 13 deforms first during compression, which suppresses deformation of the shell portion 14. Therefore, an increase in the resistance of the domain can be suppressed, and the generation of black spots can be prevented.

FIG. 2D is a domain structure where conductive particles are comprised in the core portion 13 other than in an area around the centroid. Here the effect is smaller than FIG. 2A, still the elasticity is higher in the shell portion 14 than the core portion 13, hence the core portion 13 deforms first during compression. Therefore, an increase in resistance of the domain can be suppressed, and the generation of black spots can be prevented.

In FIG. 2E, the electronic conductive agent is unevenly distributed, extending over the core portion 13 and the shell portion 14. Since the ratio of the electronic conductive agent in the area around the centroid is small, or the shell portion 14 comprises a higher ratio of the electronic conductive agent than the core portion 13, the elasticity of the shell portion 14 is relatively higher than the elasticity of the core portion 13. Hence more regions in the core portion 13 deform first, which suppresses deformation of the shell portion 14. Therefore, an increase in resistance of the domain can be suppressed, and the generation of black spots can be prevented.

FIG. 2F is a domain structure where the core portion 13 comprises a third rubber which does not comprise the electronic conductive agent, and the shell portion 14 comprises a second rubber which comprises the electronic conductive agent. Here different rubbers are used for the core portion 13 and the shell portion 14, whereby the electronic conductive agents can be clearly isolated. Further, depending on the rubber used for the shell portion 14, the elasticity of the shell portion 14 can be further increased. Hence the core portion 13 can be deformed first during compression, which greatly suppresses deformation of the shell portion 14. Therefore, an increase in resistance of the domain can be suppressed, and high effect of preventing the generation of black spots can be implemented.

### Structure not Effective to Prevent Black Spots

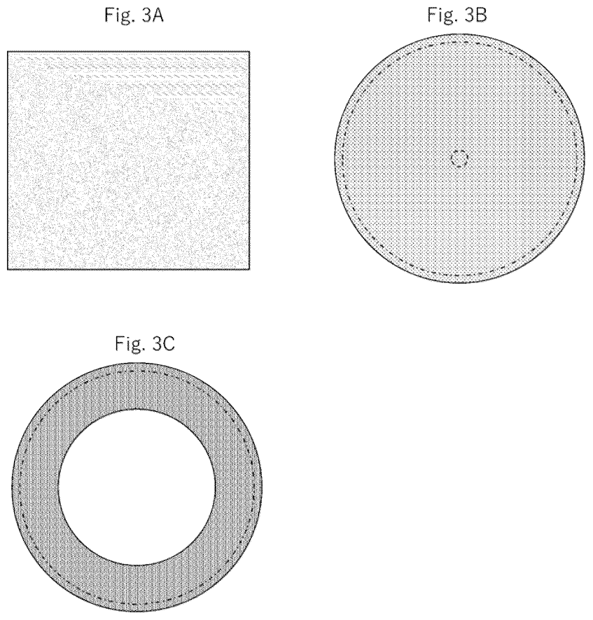

Configurations, with which the effect of preventing the generation of black spots is not implemented, will be indicated in FIGS. 3A to 3C.

FIG. 3A is a cross-section of an electrophotographic member. FIG. 3A is an electrophotographic member having a non-matrix-domain structure where the electronic conductive agent is disposed in one type of rubber. Since there is no effect to suppress deformation, the effect of preventing the generation of black spots is small.

FIG. 3B is a cross-sectional view of a domain. FIG. 3B is a structure where the electronic conductive agent is evenly dispersed in the domain. Since the deformation of the domain is relaxed by a flexible matrix not comprising the electronic conductive agent, the generation of the black spots can be more effectively prevented compared with FIG. 3A, but the effect is not sufficient.

FIG. 3C is a cross-sectional view of a domain which has a hollow structure without a core. In FIG. 3C, the core of the domain does not comprise rubber, and the shell portion comprises a rubber comprising the electronic conductive agent. In this structure, when the domain is compressed, deformation is generated at the core side boundary of the shell portion, hence the effect of preventing the generation of black spots is small.

Based on the above study, the present inventors discovered that the following conditions are required for the conductive layer to prevent the generation of black spots.

The conductive layer comprises a matrix comprising a first rubber, and a plurality of domains dispersed in this matrix. Out of cubic samples of which one side is 6 μm, which are sampled from nine locations of the conductive layer, at least eight samples satisfy the following <Condition 1> and <Condition 2> in the FIB-SEM measurement.

<Condition 1> A ratio of a total volume of the plurality of domains to a volume of the sample is 10 to 40 volume %.
<Condition 2> A number of the plurality of domains comprised in the sample is 10 to 2400.

The plurality of domains comprised in each sample that satisfies <Condition 1> and <Condition 2> comprise at least one domain A, and this domain A satisfies <Condition 3> to <Condition 6> below.

<Condition 3> The domain A comprises a second rubber and the electronic conductive agent.
<Condition 4> The centroid of the volume of this domain A exists in the domain.
<Condition 5> On a cross-section of the domain A passing through the centroid of volume, an outer peripheral region (region of a 10 nm distance from an outer edge of the domain to the centroid of volume) and an inner region (region of a 10 nm distance from the centroid of volume to the outer edge of the domain) do not overlap.
<Condition 6> In a case where the elasticity measured in the outer peripheral region on the above cross-section in <Condition 5> is Eout, and elasticity measured in the inner region is Ein, Eout/Ein>1.10 is satisfied.

The above conditions will be described in detail.

### <Condition 1> and <Condition 2>

In the conductive layer, out of the cubic samples of which one side is 6 μm, which are sampled from nine locations of the conductive layer, at least eight samples satisfy <Condition 1> and <Condition 2>. In other words, the ratio of the total volume of the plurality of domains to the volume of the sample (volume ratio of the domains) is 10 to 40 volume %. Further, a number of the plurality of domains comprised in the sample is 10 to 2400.

<Condition 1> and <Condition 2> are parameters to be the indices of the volume and quantity of the domains existing in the matrix of the electrophotographic member (hereafter also called “conductive roller”). Since <Condition 1> and <Condition 2> are indices of the occupied volume of the domains in the conductive layer, <Condition 1> and <Condition 2> can control the magnitude of compression applied to each domain.

The domains comprised in the cubic sample are both domains completely comprised in the cubic sample, and domains only partially comprised in the cubic sample. In <Condition 1> and <Condition 2>, a domain that is counted as a domain of which shell in the core-shell structure is comprised in the cubic sample. In other words, if a shell of a domain is comprised in the cubic sample even partially, the domain is counted as a domain in <Condition 1> and <Condition 2>.

In <Condition 1>, if the volume ratio of the domains in the cubic sample is 10 volume % or more, with respect to the total volume of the cubic sample, the diameter of the domain exceeds a predetermined size. Therefore expansion/contraction of the domain during compression concentrates on the core portion of the domain, and the increase in the resistance in the domain can be suppressed. Further, in order to make the shape of the domain closer to a spherical shape so as to suppress the compression of the shell portion of the domain, the volume ratio of the domains is set to 40 volume % or less. To implement both aspects, the volume ratio of the domains is preferable 20 to 40 volume %, and is more preferably 20 to 30 volume %.

In the samples satisfying <Condition 1>, out of the nine samples, an arithmetic average value of the volume ratios of the domains is 10 to 40 volume %, for example, is preferably 20 to 40 volume %, and is more preferably 20 to 30 volume %.

In <Condition 2>, if a number of domains in the sample is 10 or more, the size of one domain becomes large, and the increase in the resistance of the shell can be suppressed when the domain is compressed. In terms of an appropriate size of one domain, the number of domains is 2400 or less. The number of domains is preferably 100 to 1100, is more preferably 200 to 600, and is even more preferably 200 to 500.

A number of domains per sample in the sample that satisfies <Condition 2> is 10 to 2400, for example, is preferably 100 to 1100, is more preferably 200 to 600, and is even more preferably 200 to 500.

### Method of Controlling Volume and Quantity of Domains

To control the volume and quantity of domains, the domain diameter in the conductive layer is controlled. Specifically, the diameter of each domain dispersed in the matrix is preferably 0.30 μm or more and 2.1 μm or less. Here the size of the domain indicates a maximum ferret diameter of the domains in the conductive layer.

If the domain diameter is 0.30 μm or more, the function to concentrate the deformation to the core portion can be enhanced when the conductive roller contacts the drum, and a compressing force is applied to the domains in the conductive roller. On the other hand, if the domain diameter is 2.1 μm or less, the discharge characteristic of the matrix-domain structure can be more easily maintained.

The means for controlling the domain size will be described later as a description on control of the matrix-domain structure.

The volume ratio of the domains in the sample can be controlled by adjusting the amount of rubber used for the domains.

A number of domains in the sample can be controlled by selecting the rubber used for the matrix and the rubber used for the domain, such that the viscosities and the SP values thereof are largely different, or by the shearing force during rubber mixing. As the difference of the viscosity and the SP value of the rubber of the matrix and those of the rubber of the domain becomes larger, the number of domains can be increased, and as this difference becomes smaller, the number of domains can be decreased. Further, the number of domains can be increased if the shearing force during rubber mixing is strengthened, and the number can be decreased if the shearing force is reduced.

### Quantity Ratio of Domain A

The plurality of domains comprised in each sample that satisfy <Condition 1> and <Condition 2> comprises at least one domain A. The domain A is a domain that satisfies the later mentioned <Condition 3> to <Condition 6>.

By designing the domain Ain the following range, the effect of suppressing the increase in resistance of the domain can be enhanced. The ratio of the domain A to the total number of domains is 1 quantity % or more, to suppress the increase in resistance of the domain, and is preferably 30 quantity % or more, is more preferably 50 quantity % or more, is even more preferably 70 quantity % or more, and is even more preferably 80 quantity % or more. The upper limit is not especially restricted, and may be 100 quantity % or less, 95 quantity % or less, or 90 quantity % or less, for example. The ratio of the domain Ain quantity is preferably 30 to 100 quantity %, is more preferably 50 to 95 quantity %, is even more preferably 70 to 95 quantity %, and is even more preferably 80 to 90 quantity %.

It is preferable that the conductive layer that satisfies <Condition 1> and <Condition 2> also satisfies the following <Condition 7>. <Condition 7> A ratio of the domain A to the total number of domains is 70 quantity % or more.

In the case of increasing the ratio of the domain A using two types of rubbers, a modified second rubber, generated by adding the electronic conductive agent to the second rubber, which is generated by adding a vulcanizing agent to the second rubber used in the domain, is mixed by a pressure kneader then cured, and the first rubber are kneaded. This makes it easier to unevenly distribute the electronic conducive agent in the outer peripheral region of the domain and increase the domain A. In the case of using the third rubber, in addition to the above means, the electronic conductive agent is mixed with the second rubber using a pressure kneader, is master-batched, and is mixed with the third rubber, thereby a number of domains having the structure of the domain A can be increased.

### Area Ratio of Core and Shell of Domain A

It is preferable that the domain A has a core-shell structure constituted of a core and a shell surrounding the core. Here it is preferable that the outer peripheral region is at least a part of the shell, and the inner region is at least a part of the core. By satisfying this, a region where deformation may be generated can be concentrated to the core portion, and deformation of the shell portion can be further decreased.

In <Condition 5>, the ratio of the area of the core to the area of the domain A (core area/domain area×100) observed in the cross-section is preferably 10 to 80 area %, is more preferably 30 to 80 area %, is even more preferably 50 to 80 area %, and is even more preferably 50 to 70 area %. In this range, the core portion deforms first when the domain is deformed, hence the effect of suppressing resistance of the domain can be enhanced.

The (core area/domain area×100) can be controlled by adjusting the blending amount of rubber used for the core and the blending amount of rubber used for the shell.

In the domain A, the ratio of a total A1 of the area of the electronic conducive agent observed in the cross-section in <Condition 5>, with respect to the area A2 of this cross-section (A1/A2×100) is preferably 15.0 to 80.0 area %, is preferably 19.0 to 30.0 area %, and is even more preferably 19.0 to 27.0 area %. In this range, an excellent discharge characteristic of the matrix-domain structure can be maintained.

(A1/A2×100) can be controlled by adjusting the blending amount of the electronic conductive agent to be blended in the domain.

In the domain A, in terms of stable discharge and suppressing the increase in resistance of the domain, the ratio of the total A3 of the area of the electronic conductive agent in the outer peripheral region, observed in the cross-section in <Condition 5>, with respect to the area A4 of the outer peripheral region (A3/A4×100), is preferably 20 to 50 area %, is more preferably 30 to 50 area %, and is even more preferably 40 to 50 area %. In this range, the deformation amount of the domain becomes small due to improvement of elasticity of the outer peripheral region, and an increase in the resistance is further suppressed while maintaining a high level discharge characteristic.

(A3/A4×100) can be controlled by adjusting the blending amount of the electronic conductive agent to be blended in the rubber used for the shell.

### Confirming Matrix-Domain Structure, and Measuring Method for Volume Ratio of Domain and Quantity of Domain <Condition 1> and <Condition 2>

The volume of the domain can be measured by three-dimensionally measuring the matrix-domain structure in the conductive layer and the core-shell structure in the domain using FIB-SEM.

The FIB-SEM is a method of processing a sample using a focused ion beam (FIB), and observing an exposed cross-section using a scanning electron microscope (SEM). To examine a three-dimensional structure, many images are acquired by repeating processing and observing consecutively, and then theses SEM images are three-dimensionally reconstructed by computer-based software, so that the sample structure is constructed as a three-dimensional stereoscopic image.

Specifically, sampling is firstly performed from nine locations of the conductive layer. The nine locations should not be positioned arbitrarily, but should be at equal intervals, for example. Although depending on the shape of the conductive layer, if the conductive layer can be equally divided into nine, sampling is performed from the center portion of each portion of the nine divided regions.

In the case where the electrophotographic member is a roller shape, and the length in the axial direction (longitudinal direction) is L, the positions are determined to three locations, every 1200 in the circumferential direction of the roller ((¼))L, ( 2/4)L, (¾)L) from the edge, and one sample is cut out from each location respectively.

Then the three-dimensional measurement is performed using FIB-SEM, so as to measure the cubic-shaped images, of which one side is 6 μm, at 60 nm intervals. Here on each cross-section of (¼)L, ( 2/4)L and (¾)L, the cross-section of the conductive layer is measured at the center portion between the core metal position and the surface, in the circumferential direction of the roller at every 120°.

To appropriately observe the domain structure, pre-treatment is performed so that good contrast of the domain and the matrix can be obtained. Here dye treatment may be performed. Specifically, a dyeing agent to identify the first rubber and the second rubber respectively, such as osmium tetroxide, ruthenium tetroxide or phosphotungstic acid may be selected.

In the latter described examples, oxmium tetroxide is used for dyeing. Since the dyeing progresses as the amount of rubber double bonds and benzine rings of the rubber increases, the rubber type was determined, and the domain and matrix were distinguished.

In the case where a plurality of domains are dispersed in the matrix and the matrix has a communicating structure, it is determined that the matrix-domain structure is observed. In the case where the matrix-domain structure is observed in at least eight of the nine samples, it is determined that the conductive layer has the matrix-domain structure.

The obtained image is analyzed using the 3D visualization analysis software Avizo (registered trademark, made by FEI Co.). Here the domains and the matrix are binarized and image analysis is performed.

Then the total volume of domains comprised in one cubic shape sample of which one side is 6 μm is calculated, and the ratio of the total volume of domains to the volume of this sample (volume ratio of domains) is calculated.

Further, a number of domains in this sample is calculated. Then out of nine samples, a number of samples that satisfy <Condition 1> and <Condition 2> is determined.

### <Condition 3>

The plurality of domains comprised in each sample that satisfies <Condition 1> and <Condition 2> comprise at least one domain A. This domain A comprises the second rubber and the electronic conductive agent.

By unevenly distributing the electronic conductive agent in the shell portion where deformation in the domain is small, the increase in resistance of the domain can be suppressed. Further, the configuration to reinforce the shell portion and increase the difference of elasticities between the shell portion and the core portion can be implemented thereby. As a result, the deformation of the shell portion can be further suppressed, and the increase in resistance, due to repeated deformation, can be suppressed.

Furthermore, if an electronic conductive agent, which generates conductivity by a conductive path (e.g. carbon black), is used instead of a material which generates conductivity by the movement of ions (e.g. ion conductive agent), the increase in resistance caused by use over a long period of time can be suppressed.

In terms of the discharge characteristic, if a state where the moving discharge amount is similar is considered, the path where charges move becomes narrower, compared with the configuration of filling carbon black in the entire region of the domain, and the charge density can be improved. In other words, the charge transporting function becomes more efficient by the conductive mechanism for the shell portion alone. As a result, the present inventors think that the presence of an insulated core portion in the domain does not decrease the discharge amount and cause a charging failure, while generating the effect of suppressing the increase in resistance.

### Electronic Conductive Agent

Examples of the electronic conductive agent blended with the domain is carbon black, graphite, oxide (e.g. titanium oxide, tin oxide), metal (e.g. Cu, Ag), or particles which are coated with oxide or metal on the surface to be conductive. If necessary, two or more types of these conductive agents may be blended at an appropriate ratio. The electronic conductive agent preferably comprises carbon block of tin oxide, more preferably comprises carbon black, and ideally comprises carbon black.

Among the above mentioned electronic conductive agents, it is preferable to use a conductive carbon black, since the affinity to rubber is high and the distance between particles of the electronic conductive agent can be easily controlled. The type of carbon black to blend into the domain is not especially limited. For example, gas furnace black, oil furnace black, thermal black, lamp black, acetylene black, ketjen black and the like may be used.

Particularly the conductive carbon black of which DBP oil absorption is 40 cm³/100 g or more and 170 cm³/100 g or less is preferable, since high conductivity can be provided to the domain.

In terms of generating stable conductivity, the content of the electronic conductive agent, such as conductive carbon black, is preferably 20 parts by mass or more and 150 parts by mass or less, while the second rubber comprised in the domain is 100 parts by mass. It is more preferable that the content is 30 parts by mass or more and 100 parts by mass or less.

It is preferable that a larger amount of the conductive agent is blended compared with the case of the conductive member used for a general electrophotograph.

Thereby the volume resistivity of the domain, particularly the volume resistivity of the shell, can be controlled more easily to a desired range. The volume resistivity of the shell is preferably 1.00×10¹ to 1.00×10⁴ Ω·cm, and more preferably 1.00×10¹ to 5.00×10³ Ω·cm.

The volume resistivity of the core is preferably 1.00×10¹⁰ to 1.00×10¹⁹ Ω·cm, and more preferably 1.00×10¹³ to 1.00×10¹⁸ Ω·cm.

### Measuring Method for Volume Resistivity of Matrix, or Volume Resistivity of Core or Shell of Domain

To measure the volume resistivity, a predetermined thickness (e.g. 1 μm) of a thin slice, comprising the matrix domain structure, is cut out from the conductive layer, and a microprobe of the scanning probe microscope (SPM) or an atomic force microscope (AFM) is contacted to the matrix and domain of the thin slice.

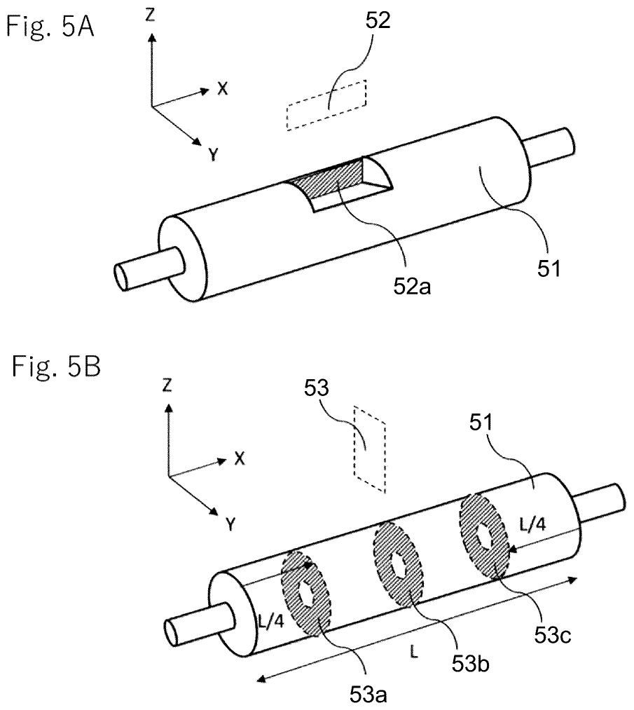

The thin slice is cut out from the conductive layer such that the thin slice 52 includes at least a part of the cross-section 52a parallel with the XZ plane, where the X axis is the longitudinal direction of the electrophotographic member 51, the Z axis is the thickness direction of the conductive layer, and the Y axis is the circumferential direction, as illustrated in FIG. 5A, for example. The thin slice may also be cut out such that the thin slice 53 includes at least a part of the YZ plane (e.g. 53a, 53b, 53c) vertical to the shaft direction of the conductive member, as illustrated in FIG. 5B, for example. In the present disclosure, the thin slice was cut out as illustrated in FIG. 5B.

Cutting out is performed, for example, with a sharp razor, a microtome, a focusing ion beam (FIB) or the like. In the present disclosure, a microtome was used.

To measure the volume resistivity, one surface of the thin slice, which was cut out from the conductive layer, is grounded. Then the microprobe of the scanning probe microscope (SPM) or the atomic force microscope (AFM) is contacted to the matrix portion on the surface of the thin slice on the opposite side of the grounded surface, and a 50V DC voltage is applied for five seconds, then an arithmetic average value is calculated from the value when the ground current value is measured for five seconds. The electric resistance value is calculated by dividing the applied voltage by this calculated arithmetic average value. Finally, using the film thickness of the thin slice, the resistance value is converted into the volume resistivity. Here an SPM and AFM can measure the film thickness of the thin slice together with the resistance value. The specific procedure will be described later.

### <Condition 4>

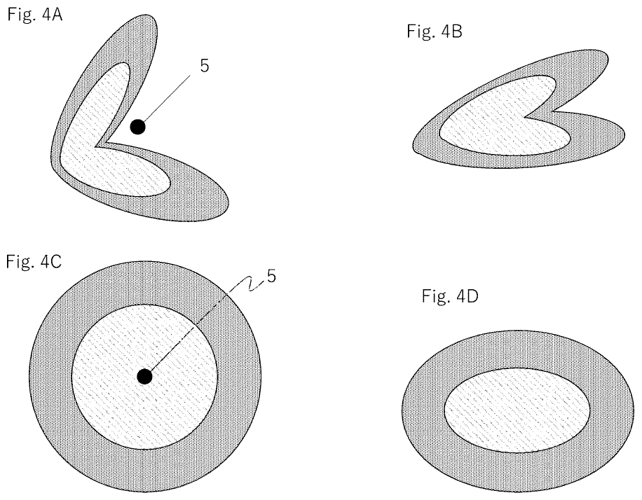

The centroid of volume of the domain A must exist inside the domain. The shape of the domain is preferably a shape close to a sphere. The centroid of volume preferably exists in the core of the domain. FIGS. 4A to 4D indicate a domain where the centroid of volume does not exist in the domain, and a domain where the centroid of volume exists in the domain.

FIG. 4A is a domain where the centroid of volume 5 does not exist inside the domain. FIG. 4B indicates a state where the compressing force is vertically applied to the domain in FIG. 4A. In the case of the domain having the shape illustrated in FIG. 4A, the domain is bent in the compressing direction, and deformation is concentrated to the shell of the bent portion. Therefore the effect of suppressing the increase in resistance of the shell portion of the domain, comprising the electronic conductive agent, cannot be expected.

FIG. 4C is a domain where the centroid of volume 5 exists inside the domain. FIG. 4D indicates a state where the compressing force is vertically applied to the domain in FIG. 4C. As illustrated in FIG. 4D, deformation is concentrated inside the domain during the vertical compression. Since the distortion of the shell portion, comprising the electronic conductive agent, can be suppressed, the increase in resistance can be suppressed.

### <Condition 5>

On the cross-section of the domain A, an outer peripheral region (10 nm region distance from the outer edge of the domain to the centroid of value) and an inner region (10 nm region distance from the centroid of volume to the outer edge of the domain) do not overlap. The outer peripheral region and the inner region that do not overlap means that the shape of the domain is close to a sphere. If the shape is close to a sphere, the stress concentrates to the inner region during compression, hence the deformation is concentrated to the core portion of the domain, and deformation of the shell portion can be reduced.

### <Condition 6>

In domain A, the elasticity of the inner region of the domain and the elasticity of the outer peripheral region of the domain satisfy a predetermined relationship. Specifically, when the elasticity measured in the outer peripheral region on the cross-section of the domain satisfying <Condition 5> is Eout, and the elasticity measured in the inner region is Ein, Eout/Ein>1.10 is satisfied. In this range, since the core portion deforms first and the deformation of the shell portion can be suppressed, the increase in resistance of the domain can be suppressed.

In terms of further suppressing the deformation of the shell portion, Eout/Ein≥1.11 is preferable, and Eout/Ein≥1.30 is more preferable. Eout/Ein is preferably more than 1.10 and 2.00 or less, is more preferably 1.11 to 1.50, and is even more preferably 1.30 to 1.50.

Eout is preferably 10 to 100 MPa, is more preferably 20 to 60 MPa, and is even more preferably 30 to 50 MPa. If Eout is in this range, deformation of the shell portion can be suppressed without diminishing the elasticity of the conductive layer.

Ein is preferably 10 to 90 MPa, is more preferably 20 to 50 MPa, and is even more preferably 25 to 40 MPa.

Confirming Method for Domain A that Satisfies <Condition 3> to <Condition 6>

Using the above measuring method based on FIB-SEM, whether each domain satisfies <Condition 3> to <Condition 6> (conditions for domain A) is confirmed for a plurality of domains comprised in a sample that satisfies <Condition 1> and <Condition 2>.

### For <Condition 3>

Using a backscattered electron image captured by FIB-SEM acquired under <Condition 1> and <Condition 2>, whether the second rubber and the electronic conductive agent are comprised can be determined based on the contrast of the matrix and the domain. Specifically, using an image analyzing apparatus (product name: LUZEX-AP, Nireco Corp.), the matrix and the domain are determined based on the contrast difference inside the domain, and thereby the electronic conductive agent (e.g. carbon black) in each domain can be determined, and the surface area thereof can be analyzed.

### For <Condition 4>

For the three-dimensional image captured by FIB-SEM acquired under <Condition 1> and <Condition 2>, the centroid of volume is calculated using the image analyzing apparatus (product name: LUZEX-AP, Nireco Corp.), and whether the centroid of volume exists inside the domain is analyzed.

### For <Condition 5>

Using FIB-SEM, a cubic shape (one side is 6 μm) is three-dimensionally measured at 60 nm intervals. After calculating the centroid of volume by the method described in <Condition 4>, it is confirmed that the 10 nm distance from the outer edge of the domain to the centroid of volume and the 10 nm distance from the centroid of volume to the outer edge of the domain do not overlap in the cross-sectional images passing through the centroid of volume, using the image analyzing apparatus (product name: LUZEX-AP, Nireco Corp.). In the case where there is no image passing through the centroid of volume in the captured cross-sectional image, the cross-sectional image closest to the centroid is selected, and analysis is implemented, with the position of centroid being a position obtained by vertical migration relative to the cross section.

### For <Condition 6>

For each cross-section sectioned at 60 nm intervals by FIB-SEM, the centroid is calculated using the image analyzing apparatus (product name: LUZEX-AP, Nireco Corp.), and the elasticity is measured for the cross-section using SPM (MFP-3Dorigin). Here the elasticity Ein of the 10 nm region from the centroid to the outer edge and the elasticity Eout of the 10 nm region from the outer edge to the centroid are measured. Each force curve is measured at 10 points, and elasticity is calculated based on the force curve using the Hertz method. The maximum value and the minimum value of the calculated elasticities at 10 points are excluded, and an average of the elasticities at the remaining 8 points is determined, and this value is regarded as the elasticity.

The same steps are repeatedly performed until the sectioning of the entire domain is over. Then the centroid of volume of the entire domain is calculated using the method mentioned in <Condition 4>, and Ein and Eout of the cross-section closest to the centroid of volume are regarded as the Ein and Eout of the cross-section passing through the centroid of volume of the domain.

Further, (A1/A2×100) is calculated. Specifically, after confirming a domain A, (A1/A2×100) is calculated for the cross-section passing through the centroid of volume of the domain A confirmed based on <Condition 5>. The arithmetic average value of all the domains A, out of the plurality of domains that are observed, is acquired.

Further, (A3/A4×100) is calculated. Specifically, after confirming a domain A, (A3/A4×100) is calculated for the cross-section passing through the centroid of the volume of the domain A confirmed based on <Condition 5>. The arithmetic average value of all the domains A, out of the plurality of domains that are observed, is acquired.

Further, (core area/domain area×100) is calculated. Specifically, after confirming a domain A, (core area/domain area×100) is calculated for the cross-section passing through the centroid of the volume of the domain A confirmed based on <Condition 5>. The arithmetic average value of all the domains A, out of the plurality of domains that are observed, is acquired.

Further, a ratio of domains A to the total number of the plurality of domains is calculated based on <Condition 7>.

Furthermore, it is confirmed whether the domain A has a core-shell structure. It is determined that the domain A has a core-shell structure if the rubber in a region including the centroid of volume and the rubber in the outer edge region are different in the cross-section passing through the centroid of volume of the domain A. In a case where there is one type of rubber in the domain A, a concentric circle (10 area %) is drawn from the centroid of volume in the cross-section of the domain A, and a ratio of the electric conductive agent to the concentric circle (ratio 1) is acquired. Further, a ratio of the electrical conductive agent to a 90 area % other than this concentric circle (ratio 2) is acquired. It is determined that the domain A has the core-shell structure if the ratio 1 is greater than the ratio 2.

### Controlling Method for Eout/Ein

To increase Eout/Ein, a ratio of the electronic conductive agent unevenly distributed in the shell portion is increased, or different rubbers are used for the core portion and the shell portion. More specifically, in the case of using different rubbers for the core portion and the shell portion, polymer having high elasticity is used for the shell portion, and polymer having low elasticity is used for the core portion.

In the case where the rubber in the shell and the rubber in the core are different, the electronic conductive agent is first mixed with the rubber in the shell, and is then mixed with the rubber in the core, whereby the electronic conductive agent can be easily unevenly distributed in the shell, that is, the electronic conductive agent can be more easily unevenly distributed in the shell portion compared with the configuration where the domain is constituted of a single polymer. As a consequence, it is preferable that the core and the shell are constituted of different polymers.

Further, it is preferable to add a larger amount of the electronic conductive agent to the shell portion, since the elasticity of the shell portion can be increased. As mentioned later, the amount of adding carbon black can be increased by selecting the DBP oil feeding amount of carbon black.

The domains comprise at least one domain A. The domain A comprises a core portion and a shell portion, and it is preferable that the shell portion comprises the electronic conductive agent. By blending more electronic conductive agent in the polymer for the shell, the effect of decreasing resistance of the domain can be more easily implemented.

To manufacture such a domain, the same polymer may be used for the core and the shell, for example, or different polymers may be used for the core and shell respectively, (described in detail later).

In the case of forming a domain having a core-shell structure using the same polymer for both the core and the shell, the first rubber is used for the matrix, and the second rubber is used for the domain. The domain, which has the core-shell structure and where the electronic conductive agent is unevenly distributed in the shell, can be formed by changing the manufacturing method, or by appropriately selecting the electronic conductive agent, the rubber type and the manufacturing conditions of the kneading to mix the rubbers.

For example, to form the domain-matrix structure, a second rubber is mixed with a vulcanizing agent in a pressure kneader and cured, and then a masterbatch comprising an electronic conductive agent in the second rubber and the first rubber are kneaded with an open roll. By molding the domain-matrix structure in two steps like this, the electronic conductive agent can be unevenly distributed in the shell portion of the domain.

Specifically, comparing the temperature C when the second rubber and the electronic conductive agent are kneaded, and the temperature D when the third rubber is added and kneaded, the temperature C is set to be higher (temperature difference is 20° C. or more). By increasing a large amount of carbon gel during kneading the second rubber and the electronic conductive agent, the electronic conductive agent is retained in the second rubber, and the movement of the electronic conductive agent between the second rubber and the third rubber can be suppressed.

In the case of forming a domain having the core-shell structure using different polymers for the core and the shell, a core-shell structure, where the shell comprises a large amount of the electronic conductive agent, can be created by controlling the SP value and the blending amount.

The configuration where three types of rubbers are used (first rubber for the matrix, second rubber for the shell of the domain, and third rubber for the core of the domain), and the electronic conductive agent is unevenly distributed in the second rubber, can be implemented by selecting an appropriate rubber based on the relationship of the SP values of the three types of rubbers to be blended.

First, rubbers of which the SP values are first rubber>second rubber>third rubber are mixed, the structure becomes such that the matrix comprises the first rubber, the shell comprises the second rubber, and the core comprises the third rubber. Therefore by mixing the electronic conductive agent with the second rubber using the pressure type kneader and creating a master batch in advance, the structure, where the electronic conductive agent is unevenly distributed in the shell, can be formed.

In terms of forming the core-shell structure, the relationship of the SP values of the first to third rubbers may be “SP value of first rubber>SP value of second rubber=SP value of the third rubber”, and “SP value of the first rubber>SP value of the second rubber>SP value of the third rubber” is preferable.

Further, the method for forming the domain using different polymers for the core portion and the shell portion is preferable since an interface between the core portion and the shell portion can be clearly formed, and compression applied to the shell can be further decreased, Therefore it is preferable that the shell comprises the second rubber and the electronic conductive agent, the core comprises the third rubber, and the second rubber and the third rubber are different rubbers.

### First Rubber

The matrix comprises the first rubber. For example, the matrix comprises the cross-linked product of the first rubber. The first rubber is a component of which blending amount is highest in rubber composition used for forming the conductive layer, and the cross-linked product of the first rubber determines the mechanical strength of the conductive layer. Therefore the first rubber expresses the strength, required for the conductive member used for electrophotography, in the conductive layer after cross-linking, and is a rubber which is phase-separated from the later mentioned second rubber, and which can form the matrix-domain structure.

The preferable examples of the first rubber are as follows: natural rubber (NR), isoprene rubber (IR), butadiene rubber (BR), styrene-butadiene rubber (SBR), butyl rubber (IIR), ethylene-propylene rubber (EPM), ethylene-propylene-diene terpolymer (EPDM), chloroprene rubber (CR), acrylonitrile-butadiene rubber (NBR), hydrogenerated NBR (H-NBR) and silicone rubber.

### Second Rubber

The domain comprises the second rubber, and comprises the cross-linked product of the second rubber, for example. It is preferable that the shell comprises the second rubber (e.g. the cross-linked product of the second rubber).

For example, the second rubber is preferably at least one selected from the group consisting of natural rubber (NR), isoprene rubber (IR), butadiene rubber (BR), acrylonitrile-butadiene rubber (NBR), styrene-butadiene rubber (SBR), butyl rubber (IIR), ethylene-propylene rubber (EPM), ethylene-propylene-diene rubber (EPDM), chloroprene rubber (CR), nitrile rubber (NBR), hydrogenerated nitrile rubber (1-NBR), silicon rubber and urethane rubber (U).

### Third Rubber

It is preferable that the core comprises the third rubber, and comprises the cross-linked product of the third rubber, for example.

For example, the third rubber is at least one selected from the group consisting of natural rubber (NR), isoprene rubber (IR), butadiene rubber (BR), acrylonitrile-butadiene rubber (NBR), styrene-butadiene rubber (SBR), butyl rubber (IR), ethylene-propylene rubber (EPM), ethylene-propylene-diene rubber (EPDM), chloroprene rubber (CR), nitrile rubber (NBR), hydrogenerated nitrile rubber (1-NBR), silicon rubber and urethane rubber (U).

The first rubber is preferably at least one selected from the group consisting of NBR. SBR and CR, and is more preferably at least one selected from the group consisting of NBR and CR, The second rubber is preferably at least one selected from the group consisting of EPDM, BR, IR, IIR and NBR. The third rubber is preferably at least one selected from the group consisting of EPDM, BR, IR, IIR and SBR, and more preferably at least one selected from the group consisting of EPDM, BR, IR and SBR. It is even more preferable that the first rubber is NBR, the second rubber is EPDM, and the third rubber is SBR.

### Manufacturing Method for Electrophotographic Member

An example of the manufacturing method of the electrophotographic member will be described below. In this example, the manufacturing method includes the following steps (A) to (C), but the present disclosure is not limited thereto as long as the configuration described in the present disclosure can be implemented.

Step (A): Step of preparing a rubber composition for forming the shell (hereafter also called “SCMB”) comprising carbon black and the second rubber.

Step (B): Step of preparing a rubber composition for forming the core (hereafter also called “CRC”) comprising the third rubber.

Step (C): Step of preparing a rubber composition for forming the matrix (hereafter also called “MRC”) comprising the first rubber.

Step (D): step of kneading SCMB and CRC to prepare the rubber composition for forming the domain (hereafter also called “DRC”).

Step (E): Step of kneading DRC and MRC to prepare the rubber composition for forming the conductive layer, which has the matrix-domain structure of which domain has the core-shell structure.

Step (F): Step of forming the layer of the rubber composition for forming the conductive layer on the substrate directly or with another layer in between, and curing this layer of the rubber composition, to form the conductive layer.

The conductive layer may be formed on the substrate using a rubber composition for forming the conductive layer, based on a known method (e.g. extrusion molding, injection molding, compression molding). If necessary, the conductive layer may be adhered to the substrate using an adhesive. The conductive layer formed on the substrate may also be vulcanized if necessary, and such a surface treatment as LV treatment may be performed thereon after polishing. In the case of performing vulcanization, a vulcanizing agent may be added to the rubber composition for forming the conducive layer in Step (F). Then vulcanization may be performed in the above mentioned curing step. The vulcanizing agent is not especially limited, and may be sulfur, for example.

The amount of the second rubber, with respect to 100 parts by mass of the first rubber, is preferably 50 to 200 parts by mass, and is more preferably 30 to 80 parts by mass.

The amount of the third rubber, with respect to 100 parts by mass of the first rubber, is preferably 5 to 60 parts by mass, and is more preferably 20 to 50 parts by mass.

### Control Method for Matrix-Domain Structure

For the dispersed particle diameter (domain size) D in the case of melt-kneading two types of incompatible polymers, the Taylor's formula, Wu's empirical formula and Tokita's formula, indicated in the following Expression (4) to (6), have been proposed (see Technical Journal: Sumitomo Chemical Co. Ltd., 2003-II, 42).

### Taylor's Formula

$$D = [ C σ / η m \cdot γ ] \cdot f ( η m / η d ) ; \qquad Expression ( 4 )$$

### Wu's Formula

$$γ \cdot D \cdot η m / σ = 4 ( η d / η m ) 0.84 \cdot η d / η m > 1 ; \qquad Expression ( 5 )$$

$$γ \cdot D \cdot η m / σ = 4 ( η d / η m - 0.84 \cdot η d / η m < 1 \qquad Expression ( 6 )$$

In Expressions (4) to (6):
D: domain size
C: constant
σ: interfacial tension
ηm: viscosity of matrix
ηd: viscosity of domain
γ: shearing speed
η: viscosity of mixed system
P: collision/union probability
φ: domain phase volume
EDK: domain phase cutting energy

Based on the above expressions, it is effective to control the following (a) to (d) to optimize the dispersion state of the domain:
(a) difference of respective interfacial tensions σ of SCMB, CRC and MRC;
(b) ratio (ηm/ηd) of viscosity (ηd) of DRC and viscosity (ηm) of MRC;
(c) shearing speed (γ) and energy amount during shearing (EDK) when DRC and MRC are kneaded in Step (E);
(d) volume fraction of DRC with respect to MRC in Step (E)

### (a) Difference of Interfacial Tensions σ of SCMB, CRC and MRC

If two types of incompatible rubbers are mixed, phase separation is normally generated. This is because the interaction between the same polymers is stronger than the interaction between different polymers, and the same polymers tend to aggregate which drops free energy for stabilization.

The interface of the phase separation structure contacts with different polymers, hence free energy becomes higher than inside the structure, which is stabilized by interactions between the same molecules. As a result, interfacial tension is generated, attempting to decrease the area contacting with different polymers, so as to decrease the free energy at the interface. If this interfacial tension is small, even different polymers are directed to be mixed uniformly so as to increase entropy. The uniformly mixed state indicates dissolution, and the SP value (solubility parameter), which is the index of solubility, tends to correlate with the interfacial tension. The measuring method for the SP value will be described latter.

The difference between the interfacial tensions can be controlled by selecting material rubbers and the like of the matrix and the domain. The difference of the absolute values of the solubility parameters of the first rubber and the second rubber is preferably 0.4 to 4.0 (J/cm³)^{0.5}, to form a stable phase separation structure. More preferable is 0.4 to 2.2 (J/cm³)^{0.5}.

In this range, the stable phase separation structure can be formed, and the maximum feret diameter of the domain can be easily controlled 0.30 μm or more and 2.1 μm or less.

In the case of mixing three or more types of incompatible rubber materials, the dispersion states will vary depending on the SP values of the rubber materials that are mixed.

In the case of forming the conductive layer of the present disclosure, which has the matrix-domain structure where the domain has the core-shell structure, it is preferable to select rubber materials so that the SP value of the rubber material constituting the shell has an intermediate value between the SP values of the rubber materials constituting the matrix and the core.

### Measurement Method for SP Value

The SP value can be accurately calculated by generating a calibration curve using a material of which SP value is already known. For this SP value, a catalog value of a material manufacturer may be used. For example, the SP values of NBR and SBR are virtually determined by the content ratios of acrylonitrile and styrene, without depending on the molecular weight.

Therefore the content ratio of acrylonitrile or styrene of the rubbers constituting the matrix and the domain are analyzed using such an analysis method as pyrolysis gas-chromatography (Py-GC) or solid-state NMR. Then the SP values can be calculated using the calibration curve obtained from a material of which SP value is known.

The SP value of isoprene rubber can be determined using an isomer structure, such as 1,2-polyisoprene, 1,3-polyisoprene, 3,4-polyisoprene, cis-1,4-polyisoprene and trans-1,4-polyisoprene. Hence just like the case of SBR and NBR, the isomer content ratio is analyzed using Py-GC, solid-state NMR or the like, and the SP value can be calculated based on a material of which SP value is known.

The SP value of the material of which SP value is known has been determined by the Hansen solubility sphere method.

(b) Ratio (ηd/ηm) of viscosity (ηd) of DRC and viscosity (ηm) of MRC:

As the viscosity of the DRC and MRC (DRC/MRC) (ηm/ηd) is closer to 1, the domain diameter can be smaller, Specifically, the viscosity ratio is preferably 1.0 or more and 2.0 or less. The viscosity ratio of DRC and MRC can be adjusted by selecting the Mooney viscosities of the material rubbers used for DRC and MRC, and the type and amount of filler that is blended.

It is also possible to add a plasticizer (e.g. paraffin oil) in an amount that does not interrupt the generation of the phase separation structure. The viscosity ratio may be adjusted by adjusting the temperature during kneading.

The viscosity of the rubber composition for forming the domain and the viscosity of the rubber composition for forming the matrix are obtained by measuring the Mooney viscosity ML₍₁₊₄₎ at the rubber temperature during kneading, based on JIS K6300-1: 2013.

As the viscosity ratio of the domain and the matrix (ηd/ηm) is closer to 1, the maximum ferret diameter of the domain can be smaller. Specifically, the preferable domain diameter can be implemented if the viscosity ratio is 2.0 or less.

(c) Shearing Speed (γ) and Energy Amount During Shearing (EDK) when DRC and MRC are Kneaded

The distance between domains can be decreased as the shearing speed increases when DRC and MRC are kneaded, and as the energy amount during shearing is larger.

The shearing speed can be increased by increasing the inner diameter of the stirring members (e.g. blade and screw of the kneading machine), so as to decrease the space from the end face of the stirring member to the inner wall of the kneading machine, and to increase the rotation frequency. The energy during shearing can be increased by increasing the rotation frequency of the stirring member, or by increasing the viscosity of rubber in DRC and rubber in MRC.

As the shearing speed and the energy amount during shearing when DRC and MRC are kneaded is higher, the maximum ferret diameter of the domain can be smaller. The shearing speed can be increased by increasing the inner diameter of the stirring member (e.g. blade and screw of the kneader), and decreasing the space from the end face of the stirring member to the inner wall of the kneader, or by increasing the rotation frequency.

(d) Volume Fraction of DRC with Respect to MRC in Step (iii)

The volume fraction of DRC, with respect to MRC, correlates with the collision/union probability of the rubber composition for forming the domain, with the rubber composition for forming the matrix. Specifically, the collision/union probability of the rubber composition for forming the domain, with the rubber composition for forming the matrix drops if the volume fraction of the rubber composition for forming the domain, with respect to the rubber composition for forming the matrix, is decreased. In other words, in a range where the necessary conductivity is obtained, the distance between the domains can be decreased by decreasing the volume fraction of the domain in the matrix.

### Domain Shape

The present inventors obtained knowledge that an amount of the electronic conductive agent comprised in one domain influences the outer shape of this domain. In other words, as the filling amount of the electronic conductive agent in one domain increases, the outer shape of this domain becomes closer to a sphere. As the number of domains which are close to a sphere shape increases, the position of the centroid in the domain becomes closer to the center of the domain, that is, deformation of the shell comprising the electronic conductive agent can be decreased.

Further, as the outer shape of the domain becomes closer to a sphere, <Condition 4> and <Condition 5> can be more easily satisfied.

According to a study by the present inventors, if a domain, where the total area of the electronic conductive agent observed in a cross-sectional area of the domain, is 20% or more, this domain can have a shape close to a sphere, although the reason for this is not clear. As a result, the outer shape of the domain can have an outer shape which could significantly reduce the concentration of the transfer of electrons between domains, which is desirable. Specifically, it is preferable that a ratio of the cross-sectional area of the electronic conductive agent that a domain comprises to the cross-sectional area of this domain is 20% or more.

When the peripheral surface of the domain has no roughness, it is preferable to satisfy the following Expression (5). If the surface is smooth, the deformation of the shell portion comprising the electronic conductive agent can be more suppressed, and an increase in resistance can be further suppressed.

$$1. \leq A / B \leq 1.10 \qquad ( 5 )$$

### (A: Circumference of Domain; B: Envelope Circumference of Domain)

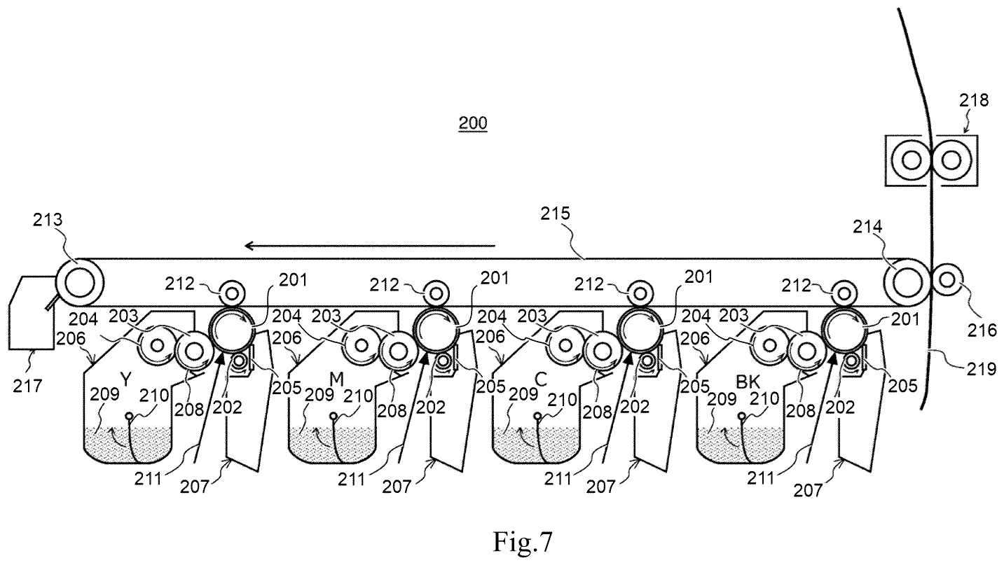

Expression (5) indicates a ratio of the circumference A of the domain with respect to the envelope circumference B of the domain. The envelope circumference here means the circumference when the protruding portions of the domain 71, observed in the observation region, are connected, as illustrated in FIG. 7.

The ratio of the circumference of the domain and the envelope circumference of the domain is 1 at the minimum, which indicates that the domain has no unevenness in a cross-sectional shape (e.g. a perfect circle, an ellipse). If this ratio exceeds 1.1, a large unevenness exists in the domain, that is, anisotropy of the electric field is generated.

### Measuring Method for Each Parameter Related to Shape of Domain

First a slice is prepared using the same method as the measurement for the volume resistivity of the matrix mentioned above. However as mentioned below, the slice is prepared by a cross-section that is vertical to the longitudinal direction of the electrophotographic member, and the shape of the domain at the fracture surface of this slice is evaluated. The reason will be described below.

FIGS. 5A and 5B are diagrams depicting the shape of the electrophotographic member 51 three-dimensionally in three axes (X, Y and Z). In FIGS. 5A and 5B, the X axis indicates a direction parallel with the longitudinal direction (axial direction) of the electrophotographic member, and the Y and Z axes indicate directions vertical to the axial direction of the electrophotographic member. The Z axis is the thickness direction of the conductive layer.

FIG. 5A is a diagram indicting an image when a slice is cut out from the electrophotographic member at a cross-section 52a parallel with an XZ plane 52. The XZ plane 52 can be rotated 360° around the axial of the electrophotographic member. Considering the state where the electrophotographic member contacts with the photosensitive drum and rotates, repeating this contact with the photosensitive drum, a cross-section 52a that is parallel with the XZ plane 52 indicates a surface that contacts with the photosensitive drum simultaneously with the XZ plane 52 at a specific timing.

Therefore in order to evaluate the shape of the domain, correlated with the electric field concentration inside the electrophotographic member, it is necessary to evaluate the cross-section parallel with the XY plane 53, which is vertical to the axial direction of the electrophotographic member, where the domain shape, including the predetermined amount of cross-section 52a, can be evaluated. For this evaluation, when the length of the conductive layer in the longitudinal direction is L, three locations are selected, that is, the cross-section 53b at the center of the conductive layer in the longitudinal direction, and the two cross-sections (53a and 53c) at the positions at L/4 from both ends of the conductive layer toward the center (FIG. 5B).

To observe the cross-sections 53a to 53c when the thickness of the conductive layer is T, the observation regions of 15 μm square are disposed at three locations (0.2 T, 0.5 T and 0.7 T) in the thickness regions at a 0.1 T to 0.9 T depth from the outer surface of each slice respectively (total of nine locations), and measurement is performed at the nine locations.

The fracture surface may be formed using such a method as a freeze-fracture method, a cross-polisher method, and a focused ion beam method (FIB). In terms of the smoothness of the fracture surface and the pre-treatment for observation, the FIB method is preferable. To observe the matrix-domain structure, a pre-treatment, such as dyeing processing and deposition processing, may be performed so that a clear contrast of the conductive phase and the insulation phase can be observed.

In the slice, after forming the fracture surface and performing pre-treatment, the matrix-domain structure can be observed using a scanning electron microscope (SEM) or a transmission electron microscope (TEM). Particularly, in terms of accuracy of quantization of the area of the domain, observation at a 1000 times to 100000 times magnification using the SEM is preferable.

The circumference and the envelope circumference of the domain and a number of domains can be measured by quantizing the captured image, as mentioned above. For the fractured surface images obtained in observation with SEM, the analysis regions of 15 μm square are extracted from nine images obtained at each observation plane respectively, using such image processing software as Image Pro Plus (made by Media Cybernetics Co.), and 8-bit grayscale processing is performed, whereby 256 gradation monochrome images are obtained. Then the whites and blacks of an image are inverted so that the domains on the fracture surface become white, then the image is binarized so as to obtain a binary image for analysis.

### Measuring Method for Cross-Sectional Area Ratio μr of Electronic Conductive Agent in Domain

The cross-sectional area ratio of the electronic conductive agent in the domain can be measured by quantizing the above mentioned binary image. For the binary image, the cross-sectional area S of each domain and the total Sc of the cross-sectional areas of the portion constituted of the conductive agent in each domain are calculated using the count function included in the image processing software Image Pro Plus (made by Media Cybernetics Co.). Then the arithmetic average value μr (%) of Sc/S is calculated.

In the case of a cylindrical charging member, of which length of the conductive layer in the longitudinal direction is L and the thickness of the conductive layer is T, cross-sections of the conductive layer in the thickness direction, as illustrated in FIG. 5B, are acquired at three locations, that is, at the center of the conductive layer in the longitudinal direction, and at the positions at L/4 from both ends of the conductive layer toward the center. For each of the acquired cross-sections, the above mentioned measurement is performed at the regions of 15 μm square at three locations (0.2 T, 0.5 T and 0.7 T) in the thickness regions at 0.1 T to 0.9 T depth from the outer surface of the conductive layer toward the support member, and the arithmetic average of the measurement values determined at a total of nine locations is calculated.

### Measuring Method for Circumference A and Envelope Circumference B of Domain

The circumference and the envelope circumference of a domain and a number of domains can be measured by quantizing the above mentioned binary image. The circumference A and the envelope circumference B of each domain in a domain size group in the image are calculated using the count function of the image processing software Image Pro Plus (made by Media Cybernetics Co.) for the binary image, and thereby the arithmetic average value of the circumference ratio A/B of the domain can be calculated.

In the case of cylindrical charging member, of which length of the conductive layer in the longitudinal direction is L and the thickness of the conductive layer is T, cross-sections of the conductive layer in the thickness direction, as illustrated in FIG. 5B, are acquired at three locations, that is, at the center of the conductive layer in the longitudinal direction, and at the positions at L/4 from both ends of the conductive layer toward the center. For each of the acquired cross-sections, the above mentioned measurement is performed in the regions of 15 μm square at three locations (0.2 T, 0.5 T and 0.7 T) in the thickness regions at 0.1 T to 0.9 T depth from the outer surface of the conductive layer toward the support member, and the arithmetic average of the measured values determined at a total of nine locations is calculated.

### Measuring Method for Shape Index of Domain

The shape index of the domain may be calculated as a quantity percentage of domains of the domain group, in which μr (%) is 20% or more and the circumference ratio A/B of the domain satisfies the above Expression (5), with respect to a total number of domains. Using the count function of the image processing software Image Pro Plus (made by Media Cybernetics Co.), number of domains in the binary image of the domain group is calculated, then a quantity percentage of the domains that satisfy μr≥20 and the above Expression (5) is determined.

In the case of a cylindrical charging member, of which length of the conductive layer in the longitudinal direction is L and the thickness of the conductive layer is T, cross sections of the conductive layer in the thickness direction, as illustrated in FIG. 5B, are acquired at three locations, that is, at the center of the conductive layer in the longitudinal direction, and at the positions at L/4 from both ends of the conducive layer toward the center. For each of the acquired cross sections, the above measurement is performed in the regions of 15 μm square at three locations (0.2 T, 0.5 T and 0.7 T) in the thickness regions at 0.1 T to 0.9 T depth from the outer surface of the conductive layer toward the support member, and the arithmetic average of the measurement values determined at the total nine locations is calculated.

### Adding Amount of Electronic Conductive Agent in Shell

An adding amount of the electronic conductive agent to blend into the shell in the domain is preferably 20% or more, or is more preferably 25% or more and 30% or less, as the ratio of the cross-section of the electronic conductive agent to the cross section of the domain. In this range, the electronic conductive agent can be density-filled in the domain. Further, the outer shape of the domain can become close to a sphere, and unevenness of the surface can be decreased. Furthermore, by adding an electronic conductive agent reinforces the shell portion and improves elasticity thereof, hence deformation of the shell portion can be reduced.

To obtain a domain in which the electronic conductive agent is filled at high density, carbon black, of which DBP oil absorption amount is 40 to 80 cm³/100 g, is particularly preferable as the electronic conductive agent. The DBP oil absorption amount (cm³/100 g) is a volume of dibutyl phthalate (DBP) which 100 g of carbon black can adsorb, and is measured according to Japan Industrial Standard (JIS) K6217-4: 2017 ((Carbon black for rubbers—basic characteristics—Part 4: How to determine oil absorption amount (including compressed sample)).

Carbon black normally has a clustered higher order structure, where primary particles (average particle diameter: 10 nm or more and 50 nm or less) are aggregated. This clustered higher order structure is simply called “structure”, and the level of the structure is quantized using the DBP oil absorption amount (cm³/100 g). If the DBP oil absorption amount of the conductive carbon black is within the above range, the structure is underdeveloped, and the aggregation of the carbon black is less, that is, the carbon black is dispersed well in the rubber. Therefore the filling amount of the electronic conductive agent into the domain can be increased, and as a result, the outer shape of the domain can become closer to a sphere. Further, the conductive carbon black, in which the DBP oil absorption amount is within the range described above, is effective because it is difficult to form aggregates.

The electronic conductive agent has conductive particles, for example. Among the conductive particles, conductive particles which comprise conductive carbon black as the main component is preferable for the following reasons: the conductive efficiency is high, affinity to rubber is high, and the distance between the conductive particles can be easily controlled.

The type of conductive carbon black to blend into the domain is not especially limited. For example, gas furnace black, oil furnace black, thermal black, lamp black, acetylene black Ketjen black and the like maybe used. However as mentioned later, carbon black of which DBP absorption is 40 to 80 cm³/100 g is particularly preferable.

By adding a large amount of carbon black to the shell in the domain, the shape of the domain becomes closer to a sphere. This is probably because the amount of carbon gel can be increased for the following reason. The carbon gel is a particulate substance in a pseudo-cross-linked state, which is generated by the adsorption of rubber molecules to the carbon black surface. The carbon gel is not dissolved even in an organic solvent in which the material rubber is dissolved. In other words, it is presumed that the carbon gel is three-dimensionally cross-linked due to the physical adsorption and the chemical adsorption of rubber molecules on the surface of the carbon black, and behaves as rubber particles, as a result, the rubber particles formed by the carbon gel become nuclei and form domains. In order to increase the carbon gel, it is preferable to blend a large amount of carbon black with the rubber, so that the carbon black which functions as an adsorbing agent is increased.

### Reinforcing Agent

Reinforced carbon black may be blended as a reinforcing agent for the shell in the domain in order to improve the ratio of the elasticity to the core portion. For the reinforced carbon black used here, FEF, GPF, SRF, MT carbon or the like, having low conductivity, can be used.

Further if necessary, fillers, processing aids, vulcanization aids, vulcanization accelerators, vulcanization acceleration aids, vulcanization retarders, antioxidants, softeners, dispersing agents, coloring agents and the like, which are commonly used as compounding agents of the rubber, may be added.

### Matrix

The matrix comprises a cross-linked product of the first rubber. The volume resistivity of the matrix is preferably 1.0×10⁸ to 1.0×10¹⁷ Ω·cm.

In the case where the volume resistivity of the matrix is 1.0×10⁸ Ω·cm or more, the influence of the conductivity of the matrix on the transfer of charges among conductive domains can be suppressed. Particularly in the case where the conductivity of the matrix is high (volume resistivity of the matrix is low), exhibiting ion conductivity, the matrix may excessively promote the transfer of charges among conductive domains, and if an electric field concentration is generated due to a slight change of the domain shapes, excessive current may flow. Therefore for the purpose of suppressing ion conductivity of the matrix as well, the volume resistivity is preferably 1.0×10⁸ Ω·cm or more.

In the case where the volume resistivity is 1.0×10¹⁷ Ω·cm or less, the conductivity required for the conductive layer in general can be obtained without interrupting the transfer of charges among the conductive domains, hence image generation problems due to insufficient charging can be prevented.

The volume resistivity is more preferably 3.0×10⁸ Ω·cm or more and 1.0×10¹⁷ Ω·cm or less. In this range, the influence of the ion conductivity of the matrix can be suppressed, and a volume resistivity more appropriate for the electrophotographic member can be obtained. The ideal range of the volume resistivity is 4.0×10⁸ Ω·cm or more and 1.0×10¹⁷ Ω·cm or less. In this range, the electric field concentration can be strongly suppressed even when high voltage is applied, and a volume resistivity more appropriate for the electrophotographic member can be obtained.

### Process Cartridge

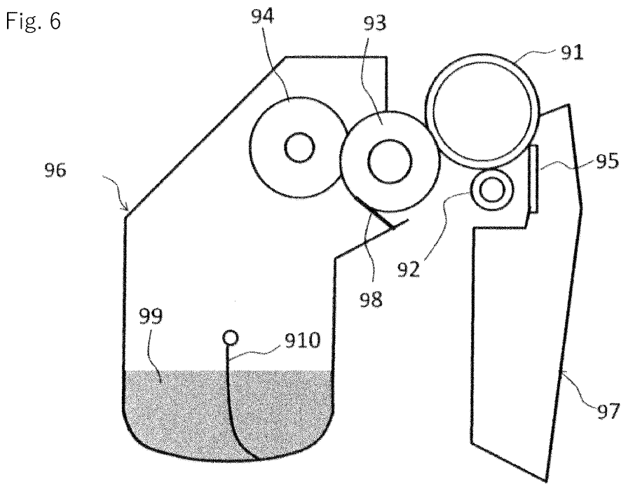

At least one aspect of the present disclosure provides a process cartridge equipped with the electrophotographic member of the present disclosure. FIG. 6 is a schematic cross-sectional view of the process cartridge for electrophotographs, which includes the electrophotographic member according to an embodiment of the present disclosure as the charging member (charging roller). This process cartridge is an integration of a developing apparatus and a charging apparatus, and is detachably attached to the main body of the electrophotographic apparatus.

The developing apparatus is an integration of at least a developing roller 93, a toner container 96 and toner 99, and may also include a toner supply roller 94, a developing blade 98 and a stirring blade 910 if necessary.

The charging apparatus is an integration of at least a photosensitive drum 91 and a charging roller 92, and may also include a cleaning blade 95 and a waste toner container 97. Voltage is applied to the charging roller 92, the developing roller 93, the toner supply roller 94, and the developing blade 98 respectively.

The electrophotographic member according to the present disclosure may be used as the charging roller, the developing roller, the developing blade and the toner supply roller. The electrophotographic member is preferably a charging member, and is more preferably a charging roller.

### Electrophotographic Image Forming Apparatus

At least one aspect of the present disclosure provides an electrophotographic image forming apparatus equipped with the electrophotographic member of the present disclosure. FIG. 7 is a schematic cross-sectional view of an electrophotographic image forming apparatus 200, which uses the electrophotographic member according to an embodiment of the present disclosure as a charging member (charging roller). This apparatus is a color electrophotographic apparatus to which the above mentioned process cartridges are detachably attached. For each process cartridge, the toner of each color (black BK, magenta M, yellow Y and cyan C) is used.

A photosensitive drum 201 rotates in the arrow direction, and is uniformly charged by a charging roller 202 to which voltage is applied from a charging bias power supply, and an electrostatic latent image is formed on the surface of the photosensitive drum 201 by an exposure light 211. Toner 209, stored in a toner container 206, is supplied to a toner supply roller 204 by a stirring blade 210, and is conveyed onto a developing roller 203. Then by a developing blade 208, which is disposed contacting the developing roller 203, the toner 209 is uniformly coated on the surface of the developing roller 203, and charges are provided to the toner 209 by triboelectric charging. The above mentioned electrostatic latent image is developed by the toner 209, which is conveyed by the developing roller 203 disposed contacting the photosensitive drum 201, and is visualized as a toner image thereby.

The visualized toner image on the photosensitive drum is transferred to an intermediate transfer belt 215, which is supported and driven by a tension roller 213 and an intermediate transfer belt driving roller 214, by a primary transfer roller 212 to which voltage is applied by a primary transfer bias power supply. A toner image of each color is sequentially superimposed and a color image is formed on the intermediate transfer belt.

A transfer material 219 is fed into the apparatus by a paper feeding roller, and is conveyed between the intermediate transfer belt 215 and a secondary transfer roller 216. The secondary transfer roller 216, to which voltage is applied from a secondary transfer bias power supply, transfers the color image on the intermediate transfer belt 215 to the transfer material 219. The color image transferred onto the transfer material 219 is fixed by a fixing unit 218, and then the transfer material 219 is discharged out of the apparatus, and print operation ends.

The untransferred toner remaining on the photosensitive drum is scraped off by a cleaning blade 205, is stored in a waste toner container 207, and the cleaned photosensitive drum 201 is subject to a repeat of the above steps. The untransferred toner remaining on the primary transfer belt is scraped off by a cleaning apparatus 217.

The above is an example of a color electrophotographic apparatus, but in the case of a monochrome electrophotographic apparatus (not illustrated), only a process cartridge containing black toner is used. The monochrome image is directly formed on the transfer member by the process cartridge and the primary transfer roller (there is no secondary transfer roller) without using the intermediate transfer belt. Then the monochrome image is fixed by the fixing unit, and the transfer material is discharged out of the apparatus, whereby print operation ends.

### EXAMPLES

Examples of the present disclosure will now be described, but the technical scope of the present disclosure is not limited thereto.

The electrophotographic members of the Examples and Comparative Examples were prepared using the following materials.

### NBR

NBR (product name: JSR NBR N230SV, acrylonitrile content: 35%, Mooney viscosity ML₍₁₊₄₎ 100° C.: 32, SP value: 20.0 (J/cm³)^{0.5}, made by JSR Co. Ltd., abbreviation: N230SV)

### Isoprene Rubber IR

isoprene rubber (product name: Nipol IR 2200L, Mooney viscosity ML₍₁₊₄₎ 100° C.: 70, SP value: 16.5 (J/cm³)^{0.5}, made by Zeon Corp, abbreviation: IR2200L)

### Butadiene Rubber BR

Butadiene rubber (product name: UBEPOL BR 150B, Mooney viscosity ML₍₁₊₄₎ 100° C.: 40, SP value: 16.8 (J/cm³)^{0.5}, made by Ube Corp., abbreviation: BR150B)

### SBR

SBR (product name: Tufdene 2003, styrene content: 25%, Mooney viscosity ML₍₁₊₄₎ 100° C.: 33, SP value: 17.0 (J/cm³)^{0.5}, made by Asahi Kasei Corp., abbreviation: T2003)

### Chloroprene Rubber (CR)

chloroprene rubber (product name: SKYPRENE B31, Mooney viscosity ML₍₁₊₄₎ 100° C.: 40, SP value: 17.4 (J/cm³)^{0.5}, made by Tosoh Corp., abbreviation: B31)

### EPDM

EPDM (product name: Esprene 505A, Mooney viscosity ML₍₁₊₄₎ 100° C.: 47, SP value: 16.0 (J/cm³)^{0.5}, made by Sumitomo Chemical Co. Ltd., abbreviation: E505A)

### Butyl Rubber (Butyl)

butyl rubber (product name: JSR Butyl, Mooney viscosity ML₍₁₊₄₎ 100° C.: 32, SP value: 15.8 (J/cm³)^{0.5}, made by JSR Co. Ltd., abbreviation: Butyl 1065)

### Electronic Conductive Agent (Conductive Particles)

carbon black (product name: TOKABLACK #7360SB, DBP absorption: 87 cm³/100 g, made by Tokai Carbon Co., Ltd., abbreviation: #7360SB)
tin oxide (product name: 5-2000, DSP absorption: 80 cm³/100 g, made by Mitsubishi Materials Electric Chemicals Co. Ltd., abbreviation: tin oxide)
carbon black (product name: Ketjen black, DSP absorption: 350 cm³/100 g, made by Lion Specialty Chemicals Co. Ltd., abbreviation: EC100J)

### Example 1

### 1. Preparing Unvulcanized Rubber Composition Used for Forming Conductive Layer

### 1-1. Preparing Carbon Master Batch (SCMB) for Forming Shell in Domain

Each material of the type and blending amount (parts by mass) shown in Table 1 was mixed using a 6-liter pressurized kneader (product name: TD6-15MDX, manufactured by Toshin Co., Ltd.) to obtain SCMB for forming a shell in a domain.

The mixing conditions are: a filling ratio of 70 volume %, a blade rotation frequency of 30 rpm, and a kneader temperature of 130° C., for 16 minutes.

TABLE 1

| | Material name | Blending amount |
|---|---|---|
| Material rubber | EPDM | 100 |
| | (product name: Esprene 505A, | |
| | made by Sumitomo Chemical | |
| | Co., Ltd.) | |
| Electronic | Carbon black | 60 |
| conductive agent | (product name: TOKABLACK # | |
| | 7360, made by Tokai Carbon Co., | |
| | Ltd.) | |
| Vulcanizatio | Zinc oxide | 5 |
| acceleration aid | (product name: Aenka, | |
| | made by Sakai Chemical Industry, | |
| | Co. Ltd.) | |
| Processing aid | Zinc stearate | 2 |
| | (product name: SZ-2000, | |
| | made by Sakai Chemical Industry | |
| | Co., Ltd.) | |

### 1-2. Preparing Rubber Composition (CRC) for Forming Shell in Domain

Each material of the type and blending amount (parts by mass) shown in Table 2 was mixed using a 6-liter pressurized kneader (product name: TD6-15MDX, manufactured by Toshin Co., Ltd.) to obtain the rubber composition for forming a shell in a domain.

The mixing conditions are: a filling ratio of 70 volume %, a blade rotation frequency of 30 rpm, and a kneader temperature of 100° C., for 16 minutes.

TABLE 2

| | Material name | Blending amount |
|---|---|---|
| Material rubber | EPDM | 100 |
| | (product name: Esprene 505A, | |
| | made by Sumitomo Chemical Co., | |
| | Ltd.) | |
| Vulcanization | Zinc oxide | 5 |
| acceleration aid | (product name: Aenka, | |
| | made by Sakai Chemical Industry, | |
| | Co. Ltd.) | |
| Processing aid | Zinc stearate | 2 |
| | (product name: SZ-2000, | |
| | made by Sakai Chemical Industry | |
| | Co., Ltd.) | |

### 1-3. Preparing Rubber Composition (MRC) for Forming Matrix

Each material of the type and blending amount (parts by mass) shown in Table 3 was mixed using a 6-liter pressurized kneader (product name: TD6-15MDX, manufactured by Toshin Co., Ltd.) to obtain the rubber composition for forming a matrix.

The mixing conditions are: a filling ratio of 70 volume %, a blade rotation frequency of 30 rpm, and a kneader temperature of 100° C., for 16 minutes.

TABLE 3

| | Material name | Blending amount |
|---|---|---|
| Material rubber | NBR | 80 |
| | (product name: JSR NBR N230SV, | |
| | made by JSR Co. Ltd.) | |
| Filler | Calcium carbonate | 60 |
| | (product name: Nanox #30, | |
| | made by Maruo Calcium Co. Ltd.) | |
| Vulcanization | Zinc oxide | 5 |
| acceleration aid | (product name: Aenka, | |
| | made by Sakai Chemical Industry, | |
| | Co. Ltd.) | |
| Processing aid | Zinc stearate | 2 |
| | (product name: SZ-2000, | |
| | made by Sakai Chemical Industry | |
| | Co., Ltd.) | |

### 1-4. Preparing Rubber Composition (DRC) for Forming Domain

Each material of the type and blending amount (parts by mass) shown in Table 4 was mixed using a 6-liter pressurized kneader (product name: TD6-15MDX, manufactured by Toshin Co., Ltd.) to obtain the rubber composition (DRC) for forming a domain.

The mixing conditions are: a filling ratio of 70 volume %, a blade rotation frequency of 30 rpm, and a kneader temperature of 130° C., for 16 minutes.

TABLE 4

| | Material name | Blending amount |
|---|---|---|
| Material rubber | Rubber composition for forming shell | 63.4 |
| | (SCMB) | |
| Material rubber | Rubber composition for forming core | 39.6 |
| | (CRC) | |

### 1-5. Adjusting Rubber Compound for Forming Conductive Layer

Each material (parts by mass) shown in Table 5 was mixed using a 6-liter pressurized kneader (product name: TD6-15MDX, manufactured by Toshin Co., Ltd.) to obtain a rubber composition (DRC) for forming a domain.

The mixing conditions are: a filling ratio of 70 volume %, a blade rotation frequency of 30 rpm, and a kneader temperature of 100° C., for 16 minutes.

TABLE 5

| | Material name | Blending amount |
|---|---|---|
| Material rubber | Rubber composition for forming | 41 |
| | domain (DRC) | |
| Material rubber | Rubber composition for forming | 59 |
| | matrix (MRC) | |

### 1-6. Preparing Unvulcanized Rubber Composition for Forming Conductive Layer

Each material of the type and blending amount (parts by mass) shown in Table 6 was mixed using an open roll to obtain an unvulcanized rubber composition for forming a conductive layer. The mixing machine used here is an open roll of which roll diameter is 12 inches.

The mixing conditions are: a front roll rotation frequency of 10 rpm and a rear roll rotation frequency of 8 rpm. After switching the roll at the left and right for a total of 20 times with a roll gap of 2 mm, tight milling is performed 10 times with a roll gap of 1.0 mm.

TABLE 6

| | Material name | Blending amount |
|---|---|---|
| Material rubber | Rubber composition for forming | 100 |
| | conductive layer | |
| Vulcanizing agent | Sulfur | 3 |
| | (product name: Sulfax PMC, | |
| | made by Tsurumi Chemical | |
| | Industry Co. Ltd.) | |
| Vulcanization | Tetra-methyl-thiuram disulfide | 1.0 |
| accelerator 1 | (product name: TT, | |
| | made by Ouchi Shinko Chemical | |
| | Industrial Co., Ltd.) | |
| Vulcanization | N-t-bytyl-2-benzothiazole | 0.5 |
| accelerator 2 | sulfenimide | |
| | (product name: SANTOCRE- | |
| | TBSI, made by FLEXSYS Corp.) | |

### 2. Preparing Electrophotographic Member (Conductive Member)

### 2-1. Forming Conductive Layer

For the substrate, a core metal (252 mm long, 6 mm outer diameter), generated by performing electroless nickel plating on the surface of free cutting steel, is prepared. This core metal is used as a conductive shaft core (substrate). Then using a roll coater, an adhesive (product name: Metaloc U-20, made by Toyokagaku Kenkyusho Co., Ltd.) is coated on the entire surface of the core metal in a 230 mm range, excluding each end 11 mm thereof. In the examples, the core metal coated with adhesive is used as the conductive support member.

Then a die (inner diameter: 10.0 mm) was attached to a tip of the cross-head extruder which included a supply mechanism of the conductive support member and a discharge mechanism of the unvulcanized rubber roller. The temperature of the extender and the cross-head was adjusted to 100° C., and the conveying speed of the conductive support member was adjusted to 60 mm/sec. Under these conditions, the unvulcanized rubber composition for forming a conductive layer was supplied using the extruder, and the outer peripheral portion of the conductive support member was coated with the unvulcanized rubber composition for forming a conductive layer inside the cross-head, whereby an unvulcanized rubber roller was obtained.

Then the unvulcanized rubber roller was placed in a hot air vulcanizing furnace (170° C.) and was heated for 60 minutes, whereby the unvulcanized rubber composition was vulcanized, and the conductive layer where a conductive layer was formed on the outer peripheral portion of the conductive support member was obtained. Then 10 mm of each end of the conductive layer was cut off, so that the length of the conductive layer in the longitudinal direction becomes 232 mm.

### 2-2. Polishing Conductive Layer

Then by polishing the surface of the conductive layer according to the polishing conditions stated in the following Polishing Conditions 1, a crown-shaped charging roller 1 (diameter of center portion is 8.5 mm, and each diameter at 90 mm positions from the center to both ends is 8.44 mm) was obtained.

### Polishing Conditions 1

A cylindrical-shaped grinding stone (made by Teiken Corp.), of which diameter is 305 mm and length is 235 mm, was provided. The type of grain, grain size, bonding degree, bonding agent and structure (grain percentage) are as follows.
Grain material: GC (green silicon carbide), (JISR6111-2002)
Grain size: #80 (average grain diameter: 177 μm, JISB4130)
Bonding degree of grain: HH (JISR6210)
Bonding agent: V4PO (Vitrified)
Structure of grain (grain percentage): 23 (content percentage of grain: 16% JISR 6242)

The polishing conditions follow. The rotation speed of grinding stone was 2100 rpm and the rotation speed of the conductive member was 250 rpm. In the rough polishing step, the entering speed of the grinding stone to the conductive member was 20 mm/sec, and the grinding stone was allowed to enter 0.24 mm after contacting the outer peripheral surface of the conductive member. In the fine polishing step, the entry speed changed to 0.5 mm/sec. and the grinding stone was allowed to enter 0.01 mm. Then the grinding stone was separated from the conductive member and polishing was completed. For the polishing method, an upper cut method, in which the rotating directions of the grinding stone and the conductive member were the same, was used.

### Examples 2 to 25

Conductive members (charging rollers of Examples 2 to 25) were prepared in the same manner as Example 1, except that the blending of the rubber and the electronic conducive agent in the unvulcanized rubber composition for forming the conductive layer is as indicated in Table 7.

### Comparative Example 1

A conductive member was prepared in the same manner as Example 1, except that the blending of the rubber and the electronic conductive agent in the unvulcanized rubber composition for forming the conductive layer is as indicated in Table 7, and the kneader temperature of SCMB is 100° C.

### Comparative Example 2

A conductive member was prepared in the same manner as Example 1, except that the blending of the rubber and the electronic conductive agent in the unvulcanized rubber composition for forming the conductive layer is as indicated in Table 7. In Comparative Example 2, the electronic conductive agent is mixed with the MRC.

### Comparative Example 3

The blending of the rubber and the electronic conductive agent in the unvulcanized rubber composition for forming the conductive layer is as indicated in Table 7. To prepare the unvulcanized rubber composition for forming the conductive layer, mixing is performed using an open roll, with a front roll rotation frequency of 10 rpm and rear roll rotation frequency of 8 rpm. After switching the roll at the left and right for a total of 20 times with a roll gap of 4 mm, tight milling is not performed. The other conditions to prepare the conductive member are the same as Example 1.

### Comparative Example 4

A conductive member was prepared in the same manner as Example 1, except that the blending of the carbon master batch (SCMB) for forming the shell in the domain is as follows.
Material rubber: 100 parts by mass
Epichlorohydrin rubber (EO-EP-AGE ternary compound) (product name: EPION ON301, made by Osaka Soda Co., Ltd.)
Mooney viscosity ML₍₁₊₄₎ 100° C.: 32, SP value: 15.8 (J/cm³)^{0.5}.
Filler: 60 parts by mass
Calcium carbonate (product name: Nanox #30, Maruo Calcium Co., Ltd.)
Plasticizer: 10 parts by mass
Alphatic polyester plasticizer (product name: Polycizer P-202, made by DIC Corp.)
Vulcanization acceleration aid: 5 parts by mass
Zinc oxide (product name: Aenka, made by Sakai Chemical Industry Co., Ltd.)
Processing aid: 1 parts by mass
Zinc stearate (product name: SZ-2000, made by Sakai Chemical Industry Co., Ltd.)

TABLE 7

| | Rubber composition for matrix (MRC) | | | | | Rubber composition for core (CRC) | | | | |
|---|---|---|---|---|---|---|---|---|---|---|
| | First rubber | | | | | Third rubber | | | | |
| | Rubber | | | | | Rubber | | | | |
| | type | Abbreviation | M | SP | Parts | type | Abbreviation | M | SP | Parts |
| Example 1 | NBR | N230SV | 32 | 20.0 | 80 | EPDM | E505A | 47 | 16.0 | 20 |
| Example 2 | SBR | T2003 | 32 | 20.0 | 80 | EPDM | E505A | 47 | 16.0 | 20 |
| Example 3 | CR | B31 | 40 | 17.4 | 80 | EPDM | E505A | 47 | 16.0 | 20 |
| Example 4 | NBR | N230SV | 32 | 20.0 | 80 | BR | BR150B | 40 | 16.8 | 20 |
| Example 5 | NBR | N230SV | 32 | 20.0 | 80 | IR | IR2200L | 70 | 16.5 | 20 |
| Example 6 | NBR | N230SV | 32 | 20.0 | 80 | Butyl | Butyl 065 | 32 | 15.8 | 20 |
| Example 7 | NBR | N230SV | 32 | 20.0 | 80 | EPDM | E505A | 47 | 16.0 | 20 |
| Example 8 | NBR | N230SV | 32 | 20.0 | 80 | EPDM | E505A | 47 | 16.0 | 20 |
| Example 9 | CR | B31 | 40 | 17.4 | 80 | EPDM | E505A | 47 | 16.0 | 20 |
| Example 10 | NBR | N230SV | 32 | 20.0 | 80 | EPDM | E505A | 47 | 16.0 | 20 |
| Example 11 | NBR | N230SV | 32 | 20.0 | 30 | EPDM | E505A | 47 | 16.0 | 20 |
| Example 12 | NBR | N230SV | 32 | 20.0 | 80 | IR | IR2200L | 70 | 16.5 | 20 |
| Example 13 | NBR | N230SV | 32 | 20.0 | 80 | BR | BR150B | 40 | 16.8 | 20 |
| Example 14 | NBR | N230SV | 32 | 20.0 | 80 | NBR | N230SV | 32 | 20.0 | 20 |
| Example 15 | NBR | N230SV | 32 | 20.0 | 80 | Butyl | Butyl 065 | 32 | 15.8 | 20 |
| Example 16 | NBR | N230SV | 32 | 20.0 | 80 | EPDM | E505A | 47 | 16.0 | 20 |
| Example 17 | NBR | N230SV | 32 | 20.0 | 80 | EPDM | E505A | 47 | 16.0 | 20 |
| Example 18 | NBR | N230SV | 32 | 20.0 | 80 | EPDM | E505A | 47 | 16.0 | 20 |
| Example 19 | NBR | N230SV | 32 | 20.0 | 80 | EPDM | E505A | 47 | 16.0 | 20 |
| Example 20 | NBR | N230SV | 32 | 20.0 | 80 | EPDM | E505A | 47 | 16.0 | 20 |
| Example 21 | NBR | N230SV | 32 | 20.0 | 80 | EPDM | E505A | 47 | 16.0 | 20 |
| Example 22 | NBR | N230SV | 32 | 20.0 | 90 | EPDM | E505A | 47 | 16.0 | 10 |
| Example 23 | NBR | N230SV | 32 | 20.0 | 70 | EPDM | E505A | 47 | 16.0 | 30 |
| Example 24 | NBR | N230SV | 32 | 20.0 | 60 | EPDM | E505A | 47 | 16.0 | 40 |
| Example 25 | NBR | N230SV | 32 | 20.0 | 60 | EPDM | E505A | 47 | 16.0 | 40 |
| Comparative | NBR | N230SV | 32 | 20.0 | 100 | EPDM | E505A | 47 | 16.0 | 40 |
| Example 1 | | | | | | | | | | |
| Comparative | NBR | N230SV | 32 | 20.0 | 80 | — | — | — | — | — |
| Example 2 | | | | | | | | | | |
| Comparative | NBR | N230SV | 32 | 20.0 | 80 | EPDM | E505A | 47 | 16.0 | 20 |
| Example 3 | | | | | | | | | | |
| Comparative | NBR | N230SV | 32 | 20.0 | 80 | EPDM | E505A | 47 | 16.0 | 20 |
| Example 4 | | | | | | | | | | |

| | Carbon maser batch for forming shell (SCMB) | | | | | | | | |
|---|---|---|---|---|---|---|---|---|---|
| | Second rubber | | | | | Electronic conductive | | Ratio | |
| | Rubber | | | | | agent | | CRC | SCMB |
| | type | Abbreviation | M | SP | Parts | Abbreviation | Parts | Parts | Parts |
| Example 1 | EPDM | E505A | 47 | 16.0 | 100 | #7360SB | 60 | 39.6 | 63.4 |
| Example 2 | EPDM | E505A | 47 | 16.0 | 100 | #7360SB | 60 | 39.6 | 63.4 |
| Example 3 | EPDM | E505A | 47 | 16.0 | 100 | #7360SB | 60 | 39.6 | 63.4 |
| Example 4 | BR | BR150B | 40 | 16.8 | 100 | #7360SB | 60 | 39.6 | 63.4 |
| Example 5 | IR | IR2200L | 70 | 16.5 | 100 | #7360SB | 60 | 39.6 | 63.4 |
| Example 6 | Butyl | Butyl 065 | 32 | 15.8 | 100 | #7360SB | 60 | 39.6 | 63.4 |
| Example 7 | EPDM | E505A | 47 | 16.0 | 100 | #7360SB | 60 | 39.6 | 63.4 |
| Example 8 | SBR | T2003 | 33 | 17.0 | 100 | #7360SB | 60 | 39.6 | 63.4 |
| Example 9 | SBR | T2003 | 33 | 17.0 | 100 | #7360SB | 60 | 39.6 | 63.4 |
| Example 10 | IR | IR2200L | 70 | 16.5 | 100 | #7360SB | 60 | 39.6 | 63.4 |
| Example 11 | BR | BR150B | 40 | 16.8 | 100 | #7360SB | 60 | 39.6 | 63.4 |
| Example 12 | SBR | T2003 | 33 | 17.0 | 100 | #7360SB | 60 | 39.6 | 63.4 |
| Example 13 | SBR | T2003 | 33 | 17.0 | 100 | #7360SB | 60 | 39.6 | 63.4 |
| Example 14 | SBR | T2003 | 33 | 17.0 | 100 | #7360SB | 60 | 39.6 | 63.4 |
| Example 15 | SBR | T2003 | 33 | 17.0 | 100 | #7360SB | 60 | 39.6 | 63.4 |
| Example 16 | SBR | T2003 | 33 | 17.0 | 100 | #7360SB | 30 | 39.6 | 63.4 |
| Example 17 | SBR | T2003 | 33 | 17.0 | 100 | #7360SB | 40 | 39.6 | 63.4 |
| Example 18 | SBR | T2003 | 33 | 17.0 | 100 | #7360SB | 80 | 39.6 | 63.4 |
| Example 19 | SBR | T2003 | 33 | 17.0 | 100 | Tin oxide | 60 | 39.6 | 63.4 |
| Example 20 | SBR | T2003 | 33 | 17.0 | 100 | #7360SB | 60 | 18.0 | 82.0 |
| Example 21 | SBR | T2003 | 33 | 17.0 | 100 | #7360SB | 60 | 70.0 | 30.0 |
| Example 22 | SBR | T2003 | 33 | 17.0 | 100 | #7360SB | 60 | 74.0 | 26.0 |
| Example 23 | SBR | T2003 | 33 | 17.0 | 100 | #7360SB | 60 | 74.0 | 26.0 |
| Example 24 | SBR | T2003 | 33 | 17.0 | 100 | #7360SB | 60 | 74.0 | 26.0 |
| Example 25 | SBR | T2003 | 33 | 17.0 | 100 | #7360SB | 60 | 85.0 | 15.0 |
| Comparative | EPDM | E505A | 47 | 16.0 | 100 | #7360SB | 60 | 39.6 | 63.4 |
| Example 1 | | | | | | | | | |
| Comparative | — | — | — | — | — | #7360SB | 48 | — | — |
| Example 2 | | | | | | | | | |
| Comparative | EPDM | E505A | 47 | 16.0 | 100 | EC100J | 60 | 39.6 | 63.4 |
| Example 3 | | | | | | | | | |

| | | | | | |
|---|---|---|---|---|---|
| Comparative | Mentioned in the specification | — | — | 39.6 | 63.4 |
| Example 4 | | | | | |

In the table, M indicates the Mooney viscosity, and SP indicates the SP value.

### 3. Characteristic Evaluation

### Measuring Matrix Volume Resistivity

The volume resistivity of the matrix was measured in the contact mode as follows, using the scanning probe microscope (SPM) (product name: Q-Scope 250, made by Quesant Instrument Corp.). The measurement environment was a temperature of 23° C. and relative humidity is 50%.

First 2 μm thick slice was cut out from the conductive layer of the charging roller 1 at a cutting temperature of −100° C., using a microtome (product name: Leica EMFCS, made by Leica Microsystems). For the cut out, cross-sections of the conductive layer in the thickness direction of the conductive layer, as indicated in FIG. 5B, were obtained as mentioned above. For each of the obtained cross-sections, an observation region of 15 μm square was disposed at three locations (0.2 T, 0.5 T and 0.7 T) in the thickness region from the outer surface of the conductive layer toward the support member at the depth 0.1 T to 0.9 T, measurement was performed, and the arithmetic average of the measured values at a total of nine locations was calculated.

Then this slice was placed on a metal plate such that one surface of the slice, corresponding to the cross-section of the conductive layer, contacts with the surface of the metal plate. Then a cantilever of the SPM was contacted to a location corresponding to the matrix on the surface of the slice, opposite the surface contacting with the meal plate. Then a 50V voltage was applied to the cantilever and the current value was measured. Further, the surface profile of this slice was observed using the SPM, and the thickness of the measurement location was calculated based on the obtained height profile. Also based on the observation result of the surface profile, the surface area of the recessed portions of the portion contacting the cantilever was calculated. Then the volume resistivity was calculated from this thickness and the surface area of the recessed portions, and the result was regarded as the volume resistivity of the matrix.

### Measuring Shell Volume Resistivity

The volume resistivity is measured in the same manner as the above mentioned measuring method for the matrix volume resistivity, except that the contact position of the cantilever is a location corresponding to the shell, and the voltage applied to the cantilever is 1V. Then the average value of the values measured at each measuring location is calculated.

### Measuring Core Volume Resistivity

The volume resistivity of the core was measured in a same manner as the above mentioned measurement method for the volume resistivity of the matrix, except that the contact position of the cantilever was a location corresponding to the core, and the voltage applied to the cantilever was 1V. Then the average value of the values measured at the measurement positions was calculated.

### Evaluating Domain Shape

The shape of a domain comprised in the conductive layer was evaluated using the following method of quantizing the observation image obtained by the scanning electron microscope (SEM) by image processing.

A thin slice (1 mm thickness) was cut out in the same way as the measurement for the volume resistivity of the domain described above. For the thin slice, a surface vertical to the axial of the conductive support member and a fracture surface of a cross-section that was parallel with this surface were acquired. When the length of the conducive layer in the longitudinal direction was L, the cut out positions from the conductive layer were obtained at three locations, that is, the center in the longitudinal direction, and the positions at L/4 from both ends of the conductive layer toward the center. Platinum is deposited on this slice so as to obtain a deposited slice. Then an image of the surface of this deposited slice is captured using a scanning electron microscope (SEM) (product name: S-4800, made by Hitachi High-Tech Corp.), at 1,000 magnification, so as to obtain an observable image

Then when the thickness of the conductive layer was T, the regions of 15 μm square deposited at three locations (0.2 T, 0.5 T and 0.7 T) in the thickness region from the outer surface of the conductive layers at the depth 0.1 T to 0.9 T (total of nine locations) of each of the three slices obtained from the three measurement positions mentioned above, were extracted as analysis images.

Then to quantize the shape of the domain in this analysis image, 8-bit grayscale processing was performed using the image processing software Image Pro Plus (made by Media Cybernetics Corp.), whereby a 256 gradation monochrome image was obtained. Then the black and white of the image were inverted so that the domains on the fracture surface became white, whereby a binary image was obtained. Then using the count function, the following items were calculated for the domain group existing in this binary image.
Circumference A (μm)
Envelope circumference B (μm)

These values are substituted in Expression (5), and the ratio of the number of domains that satisfy the conditions of Expression (5) is calculated as the quantity % with respect to the total number of the domain groups in each evaluation image, and an index of the shape of the domain is determined by calculating an average value of the evaluation images at nine locations. Table 8 indicates this result. In Table 8, the value acquired by substituting the above values in Expression (5) is indicated as “circumference ratio A/B”.

$$1. 00 ≦ A / B ≦ 1.10 \qquad ( 5 )$$

(A: circumference of domain; B: envelope circumference of domain)

### Measuring Elasticity of Core and Shell of Domain

The elasticity of the domain is measured by the procedure mentioned above.

### 4. Image Evaluation

The following evaluation was performed to confirm the stain resistance performance of the charging roller 1 under long life conditions.

First an electrophotographic type laser printer (product name: Laserjet Pro M203dw, made by HP Co.), was prepared as an electrophotographic apparatus. Then to perform the evaluation in a high-speed process, this laser printer was modified such that the number of sheets to be outputted per minute became 50 sheets/minute (A4 sized paper), which was more than the original output number of sheets. Here the output speed of the recording media was set to 246 mm/sec.

Then the charging roller 1, the electrophotographic image forming apparatus and the process cartridge were left for 48 hours in a 15° C./10% RH environment, so as to adjust to the measurement environment.

The charging roller 1, which was left in the above mentioned environment, was set as the charging roller of the process cartridge, and was attached to the laser printer.

Then in the same environment, a total of 50,000 sheets of images were consecutively outputted.

For the outputted image, alphabetic characters “E” (size: 4 pt.) were printed at a print ratio of 1.0% on A4 sized paper.

Then a halftone image (image generated by drawing horizontal lines of a 1 dot width and 2 dot space in the direction vertical to the rotating direction of the photosensitive drum) was outputted. This halftone image was visually observed, and white spot images and black spot images were evaluated based on the following standards.

### Evaluating White Spot Images on Halftone Image

Rank A: No white spot image is observed on the halftone image even if a microscope is used.
Rank B: No white spot image is visually observed on the halftone image, but is observed if a microscope is used.
Rank C: A white spot image is visually observed on a part of the halftone image.
Rank D: A white spot image is visually observed on the entire surface of the halftone image.

### Evaluating Black Spot Images on Halftone Image

Rank A: No black spot image is observed on the halftone image even if a microscope is used.
Rank B: No black spot image is visually observed on the halftone image, but is observed if a microscope is used.
Rank C: A black spot image is visually observed on a part of the halftone image.
Rank D: A black spot image is visually observed on the entire surface of the halftone image.

The same evaluation as the charging roller 1 was also performed for the charging rollers of Examples 2 to 25 and Comparative Examples 1 to 4.

Table 8 is the result thereof.

TABLE 8

| | | Domain | | | | | |
|---|---|---|---|---|---|---|---|
| | Matrix | | | Shell | | | |
| | Volume | | | Volume | | | |
| Example | resistivity/ | Volume ratio | Quantity | resistivity/ | A1/A2 × | A3/A4 × | Circumference |
| No. | Ω · cm | % | Quantity | Ω · cm | 100 | 100 | ratio A/B |
| 1 | 5.00E+08 | 10 | 2400 | 5.94E+01 | 25.0 | 20.0 | 1.06 |
| 2 | 5.00E+13 | 40 | 2400 | 5.94E+01 | 25.0 | 20.0 | 1.06 |
| 3 | 5.20E+10 | 40 | 2400 | 4.75E+01 | 25.0 | 20.0 | 1.05 |
| 4 | 5.00E+08 | 10 | 1000 | 4.96E+01 | 25.0 | 20.0 | 1.05 |
| 5 | 5.00E+08 | 30 | 1000 | 5.86E+01 | 25.0 | 20.0 | 1.04 |
| 6 | 5.00E+08 | 30 | 1000 | 6.21E+01 | 25.0 | 20.0 | 1.07 |
| 7 | 5.00E+08 | 30 | 1000 | 5.55E+01 | 25.0 | 20.0 | 1.06 |
| 8 | 5.00E+08 | 30 | 500 | 6.13E+01 | 25.0 | 50.0 | 1.07 |
| 9 | 5.20E+10 | 30 | 500 | 4.57E+01 | 25.0 | 50.0 | 1.05 |
| 10 | 5.00E+08 | 25 | 500 | 5.29E+01 | 25.0 | 50.0 | 1.07 |
| 11 | 5.00E+08 | 25 | 500 | 6.39E+01 | 25.0 | 50.0 | 1.05 |
| 12 | 5.00E+08 | 25 | 500 | 5.47E+01 | 25.0 | 50.0 | 1.06 |
| 13 | 5.00E+08 | 25 | 500 | 4.82E+01 | 25.0 | 50.0 | 1.07 |
| 14 | 5.00E+08 | 25 | 500 | 4.98E+01 | 25.0 | 50.0 | 1.05 |
| 15 | 5.00E+08 | 25 | 500 | 4.44E+01 | 25.0 | 50.0 | 1.06 |
| 16 | 5.00E+08 | 25 | 500 | 4.87E+01 | 19.4 | 50.0 | 1.12 |
| 17 | 5.00E+08 | 25 | 500 | 4.19E+03 | 20.7 | 50.0 | 1.10 |
| 18 | 5.00E+08 | 25 | 500 | 2.10E+01 | 26.8 | 50.0 | 1.02 |
| 19 | 5.00E+08 | 25 | 500 | 5.66E+01 | 25.0 | 50.0 | 1.07 |
| 20 | 5.00E+08 | 25 | 500 | 5.89E+01 | 25.0 | 50.0 | 1.05 |
| 21 | 5.00E+08 | 25 | 500 | 4.76E+01 | 25.0 | 50.0 | 1.05 |
| 22 | 5.00E+08 | 25 | 500 | 4.89E+01 | 25.0 | 50.0 | 1.05 |
| 23 | 5.00E+08 | 25 | 500 | 5.27E+01 | 25.0 | 50.0 | 1.07 |
| 24 | 5.00E+08 | 25 | 500 | 4.78E+01 | 25.0 | 50.0 | 1.04 |
| 25 | 5.00E+08 | 25 | 500 | 4.78E+01 | 25.0 | 50.0 | 1.04 |
| Comparative 1 | 2.58E+09 | 10 | 1000 | 5.21E+01 | 26.3 | 10.0 | 1.04 |
| Comparative 2 | 5.00E+08 | — | — | — | — | — | — |
| Comparative 3 | 5.00E+08 | 10 | — | — | — | — | — |
| Comparative 4 | 5.00E+08 | 10 | 2400 | 5.94E+01 | 25.0 | 20.0 | 1.06 |

| | Domain | | | | | | | |
|---|---|---|---|---|---|---|---|---|
| | Core | | | | | Elasticity of | | |
| | Volume | | | | | domain | | |
| Example | resistivity/ | C/D | A | Image evaluation | | Eout | Ein | Eout/ |
| No. | Ω · cm | % | quantity % | White spots | Black spots | MPa | Mpa | Ein |
| 1 | 3.10E+16 | 50 | 30 | A | B | 35 | 27 | 1.30 |
| 2 | 3.10E+16 | 51 | 30 | A | B | 35 | 27 | 1.30 |
| 3 | 2.90E+16 | 53 | 30 | B | B | 35 | 27 | 1.30 |
| 4 | 3.30E+15 | 50 | 30 | A | B | 35 | 27 | 1.30 |
| 5 | 8.20E+15 | 48 | 30 | A | B | 35 | 27 | 1.30 |
| 6 | 7.70E+17 | 48 | 30 | A | B | 35 | 27 | 1.30 |
| 7 | 3.20E+16 | 45 | 50 | A | B | 35 | 27 | 1.30 |
| 8 | 8.30E+13 | 60 | 70 | A | A | 35 | 27 | 1.30 |
| 9 | 7.90E+13 | 60 | 70 | B | A | 35 | 27 | 1.30 |
| 10 | 8.40E+15 | 58 | 70 | A | A | 35 | 27 | 1.30 |
| 11 | 3.13E+15 | 65 | 70 | A | A | 35 | 27 | 1.30 |
| 12 | 8.10E+13 | 65 | 70 | A | A | 35 | 27 | 1.30 |
| 13 | 7.81E+13 | 62 | 70 | A | A | 35 | 27 | 1.30 |
| 14 | 8.27E+13 | 50 | 30 | A | A | 35 | 27 | 1.30 |
| 15 | 8.34E+13 | 55 | 70 | A | A | 35 | 27 | 1.30 |
| 16 | 8.54E+13 | 50 | 70 | A | A | 30 | 27 | 1.11 |
| 17 | 8.28E+13 | 50 | 70 | A | A | 32 | 27 | 1.19 |
| 18 | 8.11E+13 | 50 | 70 | A | A | 40 | 27 | 1.48 |
| 19 | 8.05E+13 | 50 | 70 | A | A | 35 | 27 | 1.30 |
| 20 | 8.74E+13 | 11 | 70 | A | A | 35 | 27 | 1.30 |
| 21 | 7.67E+13 | 50 | 70 | A | A | 35 | 27 | 1.30 |
| 22 | 8.55E+13 | 50 | 70 | A | A | 35 | 27 | 1.30 |
| 23 | 8.80E+13 | 50 | 70 | A | A | 35 | 27 | 1.30 |
| 24 | 8.99E+13 | 50 | 70 | A | A | 35 | 27 | 1.30 |
| 25 | 8.99E+13 | 80 | 80 | A | A | 35 | 27 | 1.30 |
| Comparative 1 | — | — | — | A | D | 30 | 30 | 1.00 |
| Comparative 2 | — | — | — | D | D | — | — | — |
| Comparative 3 | — | — | — | A | D | — | — | — |
| Comparative 4 | 3.10E+16 | 50 | 30 | A | D | 25.7 | 27 | 0.95 |

In Table 8, 5.00 E+08, for example, indicates 5.00×10⁸. The circumference ratio A/B indicates a ratio of the circumference A of the domain with respect to the envelope circumference B of the domain.

In Example 1 to 25, at least eight of the samples sampled at nine locations of the conductive layer satisfied <Condition 1> and <Condition 2>. In Example 25, all nine samples satisfied <Condition 1> and <Condition 2>.

Comparative Example 1 does not satisfy Eout/Ein>1.10, and has no core-shell structure. Comparative Example 2 has no domain-matrix structure. In Comparative Example 3, there is no domain A which has a centroid of volume within the domain. Comparative Example 4 does not satisfy Eout/Ein>1.10.

Examples 1 to 25 also satisfy <Condition 3> to <Condition 6>.

The “volume ratio” of the domain is an arithmetic average value of the volume ratio of the domains in the sample that satisfies <Condition 1>. “Quantity” of the domain is a number of domains in each sample that satisfies <Condition 2>. C/D (%) is a ratio of an area of the core to the area of the domain A (core area/domain area×100). A quantity % is a ratio of domains A to the total number of domains.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2024-060840, filed Apr. 4, 2024, which is hereby incorporated by reference herein in its entirety.

What is claimed is:

1. An electrophotographic member, comprising:
a substrate having a conductive outer surface; and a conductive layer disposed on the outer surface of the substrate, wherein
the conductive layer comprises
a matrix comprising a first rubber, and
a plurality of domains dispersed in the matrix,
at least eight samples out of cubic samples of which one side is 6 μm, which are sampled from nine locations of the conductive layer, satisfy <Condition 1> and <Condition 2> below in FIB-SEM measurement:
<Condition 1> a ratio of a total volume of the plurality of domains to a volume of the sample is 10 to 40 volume %; and
<Condition 2> a number of the plurality of domains comprised in the sample is 10 to 2400, wherein
the plurality of domains comprised in each sample that satisfies the <Condition 1> and <Condition 2> comprise at least one domain A, and
the domain A satisfies <Condition 3> to <Condition 6> below:
<Condition 3> the domain A comprises a second rubber and an electronic conductive agent;
<Condition 4> a centroid of volume of the domain A exists in the domain;
<Condition 5> on a cross-section of the domain A passing through the centroid of volume, an outer peripheral region, which is a region of a 10 nm distance from an outer edge of the domain to the centroid of volume, and an inner region, which is a region of a 10 nm distance from the centroid of volume to the outer edge of the domain, do not overlap; and
<Condition 6> in a case where elasticity measured in the outer peripheral region of the cross-section in <Condition 5> is Eout, and elasticity measured in the inner region is Ein, Eout/Ein>1.10 is satisfied.

2. The electrophotographic member according to claim 1, wherein
the Eout and the Ein satisfy Eout/Ein≥1.30.

3. The electrophotographic member according to claim 1, wherein
the Eout is 10 to 100 MPa.

4. The electrophotographic member according to claim 1, wherein
in the domain A, a ratio (A1/A2×100) that is a ratio of a total A1 of an area of the electronic conductive agent observed in the cross-section in the <Condition 5>, with respect to an area A2 of the cross-section of the domain A, is 15.0 to 80.0 area %.

5. The electrophotographic member according to claim 4, wherein
in the domain A, a ratio (A3/A4×100) that is a ratio of a total A3 of an area of the electronic conductive agent in the outer peripheral region, observed in the cross-section in the <Condition 5>, with respect to an area A4 of the outer peripheral region, is 20 to 50 area %.

6. The electrophotographic member according to claim 1, wherein
the domain A has a core-shell structure constituted of a core and a shell surrounding the core, and
the outer peripheral region is at least a part of the shell, and the inner region is at least a part of the core.

7. The electrophotographic member according to claim 6, wherein
a ratio (core area/domain area×100) that is a ratio of the area of the core to the area of the domain A, observed in the cross-section in the <Condition 5>, is 10 to 80 area %.

8. The electrophotographic member according to claim 6, wherein
the shell comprises the second rubber and the electronic conductive agent,
the core comprises a third rubber, and
the second rubber and the third rubber are different from each other.

9. The electrophotographic member according to claim 8, wherein
the first rubber is NBR,
the second rubber is EPDM, and
the third rubber is SBR.

10. The electrophotographic member according to claim 1, wherein the electronic conductive agent is carbon black.

11. The electrophotographic member according to claim 1, wherein
the conductive layer that satisfies the <Condition 1> and the <Condition 2> also satisfies <Condition 7> below:
<Condition 7> a ratio of the domain A to a total number of the plurality of domains is 70 quantity % or more.

12. The electrophotographic member according to claim 1, wherein
a volume resistivity of the matrix is 1.0×10⁸ to 1.0×10¹⁷ Ω·cm.

13. The electrophotographic member according to claim 1, wherein
the domain has a core-shell structure constituted of a core and a shell surrounding the core, and
a volume resistivity of the shell is 1.00×10¹ to 1.00×10⁴ Ω·cm.

14. The electrophotographic member according to claim 1, wherein
the electrophotographic member is a charging member.

15. A process cartridge detachably attached to an electrophotographic image forming apparatus, wherein
the process cartridge comprises the electrophotographic member according to claim 1.

16. An electrophotographic image forming apparatus, wherein
the electrophotographic image forming apparatus comprising the electrophotographic member according to claim 1.
